(19) United States
(12) Patent Application Publication
(10) Pub. No.: US 2018/0190431 A1
(43) Pub. Date: Jul. 5, 2018

(54) ELECTRONIC DEVICE

(71) Applicant: TDK CORPORATION, Tokyo (JP)

(72) Inventor: Tatsuya FUKUNAGA, Tokyo (JP)

(73) Assignee: TDK CORPORATION, Tokyo (JP)

(21) Appl. No.: 15/740,571

(22) PCT Filed: Aug. 24, 2016
(86) PCT No.: PCT/JP2016/074585

§ 371 Date: Dec. 28, 2017

(30) Foreign Application Priority Data
Aug. 26, 2015 (JP) 2015-166361
Sep. 15, 2015 (JP) 2015-181374
Nov. 26, 2015 (JP) 2015-230450
Nov. 26, 2015 (JP) 2015-230451

(51) Int. Cl. H01G 4/232; H01G 4/30; H01G 4/005; H01G 4/12

(52) U.S. Cl. CPC H01G 4/232; H01G 4/12; H01G 4/005; H01G 4/30

(57) ABSTRACT

An electronic device in which an equivalent series inductance including a parasitic inductance of a capacitor and an inductance of wiring of a mount board may be decreased is provided. An electronic device includes a first terminal conductor, a second terminal conductor, a third terminal conductor, and a fourth terminal conductor; one or a plurality of first inner electrodes, and one or a plurality of second inner electrodes; and a connection conductor. The one or plurality of first inner electrodes are connected to the first terminal conductor. The one or plurality of second inner electrodes are connected to the second terminal conductor. Each of the first inner electrodes and each of the second inner electrodes are stacked via a dielectric. The third terminal conductor and the fourth terminal conductor are connected by the connection conductor.

### TECHNICAL FIELD

The present invention relates to a capacitor in which an equivalent series inductance (ESL) is decreased.

### BACKGROUND ART

In recent years, the processing speed and integration of a CPU (central processing unit) used for an information processing apparatus have been increased, and hence the operating frequency has been increased and also the current consumption has been markedly increased. Accordingly, the operating voltage has tended to be decreased for decreasing the power consumption. Hence, in a power source for supplying electric power to the CPU, further high-speed large current fluctuation (noise current) has been generated, and it has been very difficult to suppress voltage fluctuation caused by the current fluctuation not to exceed an allowable value of the power source. Due to this, a multilayer capacitor as a smoothening capacitor has been arranged in the periphery of the CPU in a manner connected to the power source, and has been frequently used as a measure for stabilizing the power source. That is, by quick charging/discharging during high-speed transient fluctuation of current, the current has been supplied from the multilayer capacitor to the CPU, and hence the voltage fluctuation of the power source has been suppressed.

As the operating frequency of the CPU has been further increased and the operating voltage thereof has been further decreased, the speed and magnitude of the current fluctuation have been further increased. The equivalent series inductance (ESL) owned by the multilayer capacitor itself has become largely affecting the voltage fluctuation of the power source. Consequently, since the ESL disturbs the charging/discharging of the multilayer capacitor when the current fluctuates, the voltage fluctuation of the power source has been likely increased, and the CPU has become unable to adapt to an increase in speed in future.

In this regard, for example, there is suggested a multilayer capacitor as disclosed in PTL 1, PTL 2, or PTL 3. In the multilayer capacitor, inner electrodes and side-surface terminals are arranged so that currents flowing through adjacent terminal electrodes flow in mutually opposite directions. Hence, a negative mutual inductance is provided, a parasitic inductor component owned by the capacitor is decreased, and thus a low ESL is realized.

### CITATION LIST

### Patent Literature

PTL 1: Japanese Unexamined Patent Application Publication No. 2001-284170

PTL 2: Japanese Unexamined Patent Application Publication No. 2001-284171

PTL 3: Japanese Unexamined Patent Application Publication No. 2003-168621

### SUMMARY OF INVENTION

### Technical Problem

The technologies described in PTL 1, PTL 2, and PTL 3 each decrease the parasitic inductance of a single capacitor element; however, in fact, the inductance of wiring of a mount board may be an obstructive factor, in addition to the capacitor, when the voltage fluctuation of a power source is suppressed. In light of the above-described fact, it is an object of the present invention to provide an electronic device in which an equivalent series inductance including a parasitic inductance of a capacitor and an inductance of wiring of a mount board may be decreased.

### Solution to Problem

An electronic device according to the present invention includes a first terminal conductor, a second terminal conductor, a third terminal conductor, and a fourth terminal conductor; one or a plurality of first inner electrodes, and one or a plurality of second inner electrodes; and a connection conductor. The one or plurality of first inner electrodes are connected to the first terminal conductor. The one or plurality of second inner electrodes are connected to the second terminal conductor. Each of the first inner electrodes and each of the second inner electrodes are stacked via a dielectric. The third terminal conductor and the fourth terminal conductor are connected by the connection conductor.

With the electronic device having the above-described feature, one of the first terminal conductor and the second terminal conductor is connected to a DC power source layer in a mount board that supplies a DC power source via wiring of the mount board, and the other one is connected to a ground layer of the mount board via wiring of the mount board. Accordingly, a direct-current voltage is applied between the first inner electrode and the second inner electrode. Also, both the third terminal conductor and the fourth terminal conductor are connected to a conductor layer, such as the DC power source layer or the ground layer, via wiring of the mount board, and hence a closed loop conductor is formed by the connected conductor layer, such as the DC power source layer or the ground layer, the wiring of the mount board used for the connection, the third terminal conductor, the fourth terminal conductor, and the connection conductor. The loop conductor is magnetically coupled to an equivalent series inductor owned by a capacitor that is formed by the first inner electrode and the second inner electrode, the first terminal conductor, the second terminal conductor, and the wiring of the mount board, and hence a counter-electromotive force is generated at the loop conductor to disturb the temporal variation in magnetic flux corresponding to the equivalent series inductance on the basis of Faraday's law. Accordingly, the equivalent series inductance can be decreased.

Further, in the electronic device according to the present invention, the connection conductor is preferably arranged to overlap the first inner electrode and the second inner electrode when viewed in a stack direction of the first inner electrode and the second inner electrode.

With the electronic device having the above-described feature, sufficient magnetic coupling is obtained between the loop conductor and the equivalent series inductor of the capacitor, the first terminal conductor, the second terminal conductor, and the wiring of the mount board, and the equivalent series inductance can be further reliably decreased.

Further, preferably, in the electronic device according to the present invention, the connection conductor is formed outside a stack region in which the first inner electrode and the second inner electrode are stacked via the dielectric, and is not formed in the stack region.

With the electronic device having the above-described feature, since the connection conductor is not formed in the stack region, the equivalent series inductance of the capacitor, the first terminal conductor, the second terminal conductor, and the wiring of the mount board can be decreased without affecting the capacity of the capacitor.

Further, in the electronic device according to the present invention, the electronic device preferably has four side surfaces. Each of the first terminal conductor, the second terminal conductor, the third terminal conductor, and the fourth terminal conductor is preferably formed along one of two side surfaces from among the four side surfaces; or the first terminal conductor, the second terminal conductor, the third terminal conductor, and the fourth terminal conductor are preferably formed along one and the same side surface from among the four side surfaces.

With the electronic device having the above-described feature, a terminal conductor is not formed on at least two of the side surfaces. Hence, the same type of electronic device or another part can be mounted with a reduced space at a position facing each of the two side surfaces without a terminal conductor. A high mounting density of electronic devices and parts can be attained.

Further, in the electronic device according to the present invention, the first terminal conductor, the second terminal conductor, the third terminal conductor, and the fourth terminal conductor are preferably formed along the same bottom surface.

With the electronic device having the above-described feature, a terminal conductor is not formed on the side surfaces. Hence, the same type of electronic device or another part can be mounted with a reduced space at a position facing each of the side surfaces without a terminal conductor. A high mounting density of electronic devices and parts can be attained.

Also, an electronic device according to the present invention includes a first terminal conductor, a second terminal conductor, and a third terminal conductor; one or a plurality of first inner electrodes, and one or a plurality of second inner electrodes; and a first connection conductor. The one or plurality of first inner electrodes are connected to the first terminal conductor. The one or plurality of second inner electrodes are connected to the second terminal conductor. Each of the first inner electrodes and each of the second inner electrodes are stacked via a dielectric. The first terminal conductor and the third terminal conductor are connected by the first connection conductor.

With the electronic device having the above-described feature, one of the first terminal conductor and the second terminal conductor is connected to a DC power source layer in a mount board that supplies a DC power source via wiring of the mount board, and the other one is connected to a ground layer of the mount board via wiring of the mount board. Accordingly, a direct-current voltage is applied between the first inner electrode and the second inner electrode. Also, the third terminal conductor is connected to a layer (DC power source layer or ground layer) having the same electric potential as that of the first terminal conductor, via wiring of the mount board, and hence a closed loop conductor is formed by the connected DC power source layer or ground layer, the wiring of the mount board used for the connection, the first terminal conductor, the third terminal conductor, and the first connection conductor. The loop conductor is magnetically coupled to an equivalent series inductor owned by a capacitor that is formed by the first inner electrode and the second inner electrode, the first terminal conductor, the second terminal conductor, and the wiring of the mount board, and hence a counter-electromotive force is generated at the loop conductor to disturb the temporal variation in magnetic flux corresponding to the equivalent series inductance on the basis of Faraday's law. Accordingly, the equivalent series inductance can be decreased.

Further, in the electronic device according to the present invention, the first connection conductor is preferably arranged to overlap the first inner electrode and the second inner electrode when viewed in a stack direction of the first inner electrode and the second inner electrode.

With the electronic device having the above-described feature, sufficient magnetic coupling is obtained between the loop conductor including the first connection conductor, and the equivalent series inductor of the capacitor, the first terminal conductor, the second terminal conductor, and the wiring of the mount board. The equivalent series inductance can be further reliably decreased.

Further, preferably, in the electronic device according to the present invention, the first connection conductor is formed outside a stack region in which the first inner electrode and the second inner electrode are stacked via the dielectric, and is not formed in the stack region.

With the electronic device having the above-described feature, since the first connection conductor is not formed in the stack region, the equivalent series inductance of the capacitor, the first terminal conductor, the second terminal conductor, and the wiring of the mount board can be decreased without affecting the capacity of the capacitor.

Further, in the electronic device according to the present invention, the electronic device preferably has four side surfaces. Each of the first terminal conductor, the second terminal conductor, and the third terminal conductor is preferably formed along one side surface from among the four side surfaces. At least two of the first terminal conductor, the second terminal conductor, and the third terminal conductor are preferably formed along the same side surface.

With the electronic device having the above-described feature, a terminal conductor is not formed on at least two of the side surfaces. Hence, the same type of electronic device or another part can be mounted with a reduced space at a position facing each of the two side surfaces without a terminal conductor. A high mounting density of electronic devices and parts can be attained.

Further, in the electronic device according to the present invention, the first terminal conductor, the second terminal conductor, and the third terminal conductor are preferably formed along the same bottom surface.

With the electronic device having the above-described feature, a terminal conductor is not formed on the side surfaces. Hence, the same type of electronic device or another part can be mounted with a reduced space at a position facing each of the side surfaces without a terminal conductor. A high mounting density of electronic devices and parts can be attained.

Further, preferably, the electronic device according to the present invention further includes a fourth terminal conductor and a second connection conductor, and the second terminal conductor and the fourth terminal conductor are connected by the second connection conductor.

With the electronic device having the above-described feature, a closed loop conductor can be further formed by connecting the fourth terminal conductor to a layer (DC power source layer or ground layer) with the same electric potential as that of the second terminal conductor. The equivalent series inductance of the capacitor, the first terminal conductor, the second terminal conductor, and the wiring of the mount board can be further decreased.

Further, in the electronic device according to the present invention, the second connection conductor is preferably arranged to overlap the first inner electrode and the second inner electrode when viewed in a stack direction of the first inner electrode and the second inner electrode.

With the electronic device having the above-described feature, sufficient magnetic coupling is obtained between the loop conductor including the second connection conductor, and the equivalent series inductor of the capacitor, the first terminal conductor, the second terminal conductor, and the wiring of the mount board, and the equivalent series inductance can be further reliably decreased.

Further, preferably, in the electronic device according to the present invention, the second connection conductor is formed outside a stack region in which the first inner electrode and the second inner electrode are stacked via the dielectric, and is not formed in the stack region.

With the electronic device having the above-described feature, since the second connection conductor is not formed in the stack region, the equivalent series inductance of the capacitor, the first terminal conductor, the second terminal conductor, and the wiring of the mount board can be decreased without affecting the capacity of the capacitor.

Further, in the electronic device according to the present invention, the electronic device has preferably four side surfaces. Each of the first terminal conductor, the second terminal conductor, the third terminal conductor, and the fourth terminal conductor is preferably formed along one of two side surfaces from among the four side surfaces; or the first terminal conductor, the second terminal conductor, the third terminal conductor, and the fourth terminal conductor are preferably formed along one and the same side surface from among the four side surfaces.

With the electronic device having the above-described feature, a terminal conductor is not formed on at least two of the side surfaces. Hence, the same type of electronic device or another part can be mounted with a reduced space at a position facing each of the two side surfaces without a terminal conductor. A high mounting density of electronic devices and parts can be attained.

Further, in the electronic device according to the present invention, the first terminal conductor, the second terminal conductor, the third terminal conductor, and the fourth terminal conductor are preferably formed along the same bottom surface.

With the electronic device having the above-described feature, a terminal conductor is not formed on the side surfaces. Hence, the same type of electronic device or another part can be mounted with a reduced space at a position facing each of the side surfaces without a terminal conductor. A high mounting density of electronic devices and parts can be attained.

### Advantageous Effects of Invention

With the present invention, the electronic device in which the equivalent series inductance of the capacitor and the wiring of the mount board may be decreased can be provided.

### BRIEF DESCRIPTION OF DRAWINGS

FIG. 1 is a perspective view of an electronic device according to a first embodiment of the present invention.

FIG. 2 is a cross-sectional view cut along line A-A in FIG. 1.

FIG. 3 is a cross-sectional view cut along line B-B in FIG. 1.

FIG. 4 illustrates the connection relationship between a circuit topology of the inside of the electronic device according to the first embodiment of the present invention and first to fourth terminal conductors.

FIG. 5 is an exploded perspective view illustrating inner electrodes stacked in the electronic device according to the first embodiment of the present invention.

FIG. 6 is an explanatory view of eddy current generated due to a change in magnetic flux on the basis of Faraday's law.

FIG. 7 is a cross-sectional view in a state in which the electronic device according to the first embodiment of the present invention is mounted on a mount board.

FIG. 8 is a cross-sectional view in the state in which the electronic device according to the first embodiment of the present invention is mounted on the mount board.

FIG. 9 illustrates an equivalent circuit example in the state in which the electronic device according to the first embodiment of the present invention is mounted on the mount board.

FIG. 10 is a graph showing calculation results by a circuit simulator of the equivalent circuit example illustrated in FIG. 9.

FIG. 11 is a cross-sectional view of an electronic device according to a second embodiment of the present invention.

FIG. 12 illustrates the connection relationship between a circuit topology of the inside of an electronic device according to another example of the first embodiment of the present invention and first to fourth terminal conductors.

FIG. 13 illustrates the connection relationship between a circuit topology of the inside of an electronic device according to still another example of the first embodiment of the present invention and first to fourth terminal conductors.

FIG. 14 illustrates the connection relationship between a circuit topology of the inside of an electronic device according to yet another example of the first embodiment of the present invention and first to fourth terminal conductors.

FIG. 15 is a perspective view of an electronic device according to a third embodiment of the present invention.

FIG. 16 is an exploded perspective view illustrating inner electrodes stacked in the electronic device according to the third embodiment of the present invention.

FIG. 17 illustrates the connection relationship between a circuit topology of the inside of the electronic device according to the third embodiment of the present invention and first to fourth terminal conductors.

FIG. 18 is a perspective view of an electronic device according to a fourth embodiment of the present invention.

FIG. 19 is a cross-sectional view cut along line A-A in FIG. 18.

FIG. 20 is a cross-sectional view cut along line B-B in FIG. 18.

FIG. 21 illustrates the connection relationship between a circuit topology of the inside of the electronic device according to the fourth embodiment of the present invention and first to fourth terminal conductors.

FIG. 22 is an exploded perspective view illustrating inner electrodes stacked in the electronic device according to the fourth embodiment of the present invention.

FIG. 23 is an explanatory view of eddy current generated due to a change in magnetic flux on the basis of Faraday's law.

FIG. 24 is a cross-sectional view in a state in which the electronic device according to the fourth embodiment of the present invention is mounted on a mount board.

FIG. 25 is a cross-sectional view in the state in which the electronic device according to the fourth embodiment of the present invention is mounted on the mount board.

FIG. 26 illustrates an equivalent circuit example in the state in which the electronic device according to the fourth embodiment of the present invention is mounted on the mount board.

FIG. 27 is a graph showing calculation results by a circuit simulator of the equivalent circuit example illustrated in FIG. 26.

FIG. 28 is a perspective view of an electronic device according to a fifth embodiment of the present invention.

FIG. 29 is a cross-sectional view cut along line C-C in FIG. 28.

FIG. 30 is a cross-sectional view cut along line D-D in FIG. 28.

FIG. 31 is a cross-sectional view cut along line E-E in FIG. 28.

FIG. 32 illustrates the connection relationship between a circuit topology of the inside of the electronic device according to the fifth embodiment of the present invention and first to fourth terminal conductors.

FIG. 33 is an exploded perspective view illustrating inner electrodes stacked in the electronic device according to the fifth embodiment of the present invention.

FIG. 34 is a cross-sectional view in a state in which the electronic device according to the fifth embodiment of the present invention is mounted on a mount board.

FIG. 35 is a cross-sectional view of an electronic device according to a sixth embodiment of the present invention.

FIG. 36 illustrates the connection relationship between a circuit topology of the inside of an electronic device according to another example of the fifth embodiment of the present invention and first to fourth terminal conductors.

FIG. 37 illustrates the connection relationship between a circuit topology of the inside of an electronic device according to still another example of the fifth embodiment of the present invention and first to fourth terminal conductors.

FIG. 38 illustrates the connection relationship between a circuit topology of the inside of an electronic device according to yet another example of the fifth embodiment of the present invention and first to fourth terminal conductors.

FIG. 39 illustrates the connection relationship between a circuit topology of the inside of an electronic device according to a further example of the fifth embodiment of the present invention and first to fourth terminal conductors.

FIG. 40 is a perspective view of an electronic device according to a seventh embodiment of the present invention.

FIG. 41 is an exploded perspective view illustrating inner electrodes stacked in the electronic device according to the seventh embodiment of the present invention.

FIG. 42 illustrates the connection relationship between a circuit topology of the inside of the electronic device according to the seventh embodiment of the present invention and first to third terminal conductors.

FIG. 43 is a perspective view of an electronic device according to an eighth embodiment of the present invention.

FIG. 44 is an exploded perspective view illustrating inner electrodes stacked in the electronic device according to the eighth embodiment of the present invention.

FIG. 45 illustrates the connection relationship between a circuit topology of the inside of the electronic device according to the eighth embodiment of the present invention and first to fourth terminal conductors.

### DESCRIPTION OF EMBODIMENTS

Embodiments of the present invention are described below in detail with reference to the drawings. The following description gives examples of part of the embodiments of the present invention. The present invention is not limited to those embodiments, and various embodiments are included in the scope of the present invention as long as those have the technical idea of the present invention. Components and combinations of the components in each embodiment are examples, and a component can be added, omitted, replaced, and changed in a various way within the range not departing from the spirit of the present invention.

### First Embodiment

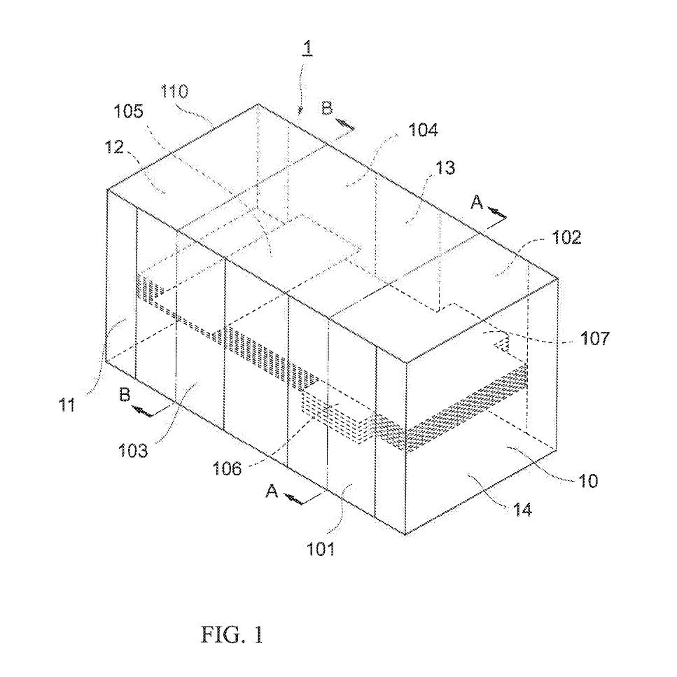

FIG. 1 is a perspective view illustrating a general configuration example of an electronic device 1 according to a first embodiment of the present invention. The electronic device 1 has a rectangular-parallelepiped shape as illustrated in FIG. 1, and has a mount surface 10 (a bottom surface of the electronic device 1 in FIG. 1), a side surface 11, a side surface 12, a side surface 13, and a side surface 14. The side surface 11, the side surface 12, the side surface 13, and the side surface 14 intersect with the mount surface 10. The electronic device 1 includes a first terminal conductor 101, a second terminal conductor 102, a third terminal conductor 103, and a fourth terminal conductor 104. The first terminal conductor 101 and the second terminal conductor 102 are formed along different side surfaces (the side surface 11 and the side surface 13) (the first terminal conductor 101 is formed along the side surface 11, and the second terminal conductor 102 is formed along the side surface 13). The third terminal conductor 103 and the fourth terminal conductor 104 are formed along different side surfaces (the side surface 11 and the side surface 13) (the third terminal conductor 103 is formed along the side surface 11, and the fourth terminal conductor 104 is formed along the side surface 13). The first terminal conductor 101 and the third terminal conductor 103 are formed along the same side surface 11, and the second terminal conductor 102 and the fourth terminal conductor 104 are formed along the same side surface 13. The first terminal conductor 101, the second terminal conductor 102, the third terminal conductor 103, and the fourth terminal conductor 104 are separated from one another via a dielectric 110.

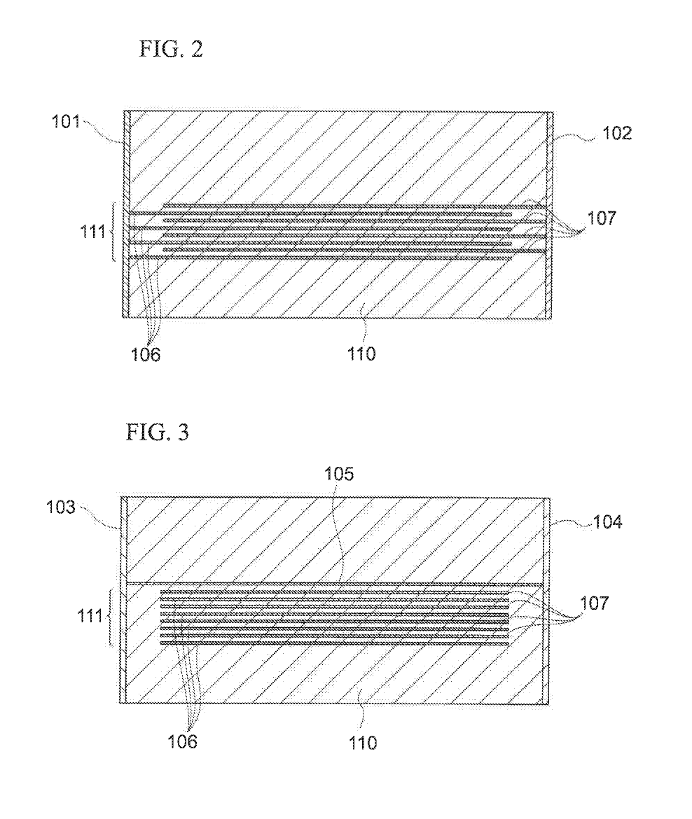

Also, the electronic device 1 includes a plurality of first inner electrodes 106, a plurality of second inner electrodes 107, and a connection conductor 105. FIG. 2 is a cross-sectional view along line A-A in FIG. 1. As illustrated in FIG. 2, the plurality of first inner electrodes 106 are connected to the first terminal conductor 101, the plurality of second inner electrodes 107 are connected to the second terminal conductor 102, each of the first inner electrodes 106 and each of the second inner electrodes 107 are stacked via the dielectric 110, and hence a stack region 111 is formed. The stack region 111 functions as a capacitor.

An example of the dielectric 110 may be a dielectric ceramic material, such as calcium zirconate or aluminum oxide. Alternatively, the dielectric 110 may be an organic material or an electrolytic solution.

FIG. 3 is a cross-sectional view along line B-B in FIG. 1. As illustrated in FIGS. 1 and 3, the connection conductor 105 is connected to both the third terminal conductor 103 and the fourth terminal conductor 104.

Also, as illustrated in FIG. 3, the connection conductor 105 is arranged to be separated from the first inner electrodes 106 and the second inner electrodes 107. Further, as illustrated in FIGS. 1 and 3, the connection conductor 105 is arranged to overlap the first inner electrodes 106 and the second inner electrodes 107 when viewed in a stack direction of the first inner electrodes 106 and the second inner electrodes 107.

Also, as illustrated in FIG. 3, the connection conductor 105 is formed outside the stack region 111, and is not formed in the stack region 111.

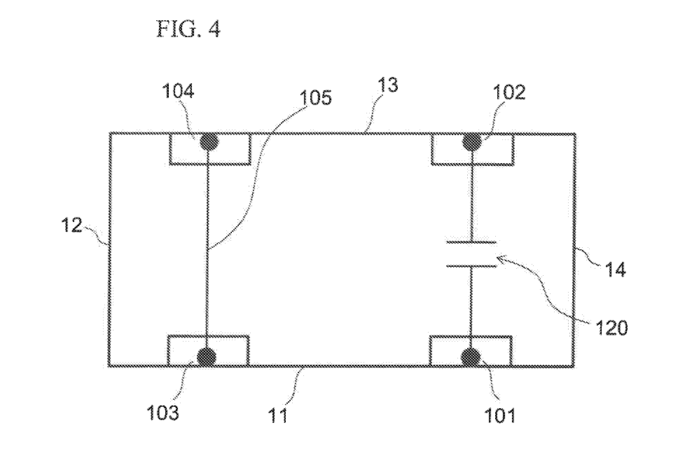

When the connection relationship between a topology of a circuit formed in the electronic device 1 and the first to fourth terminal conductors 101, 102, 103, and 104 is illustrated, the relationship may be one in FIG. 4. The stack region 111 functions as a capacitor 120. The capacitor 120 is connected between the first terminal conductor 101 and the second terminal conductor 102.

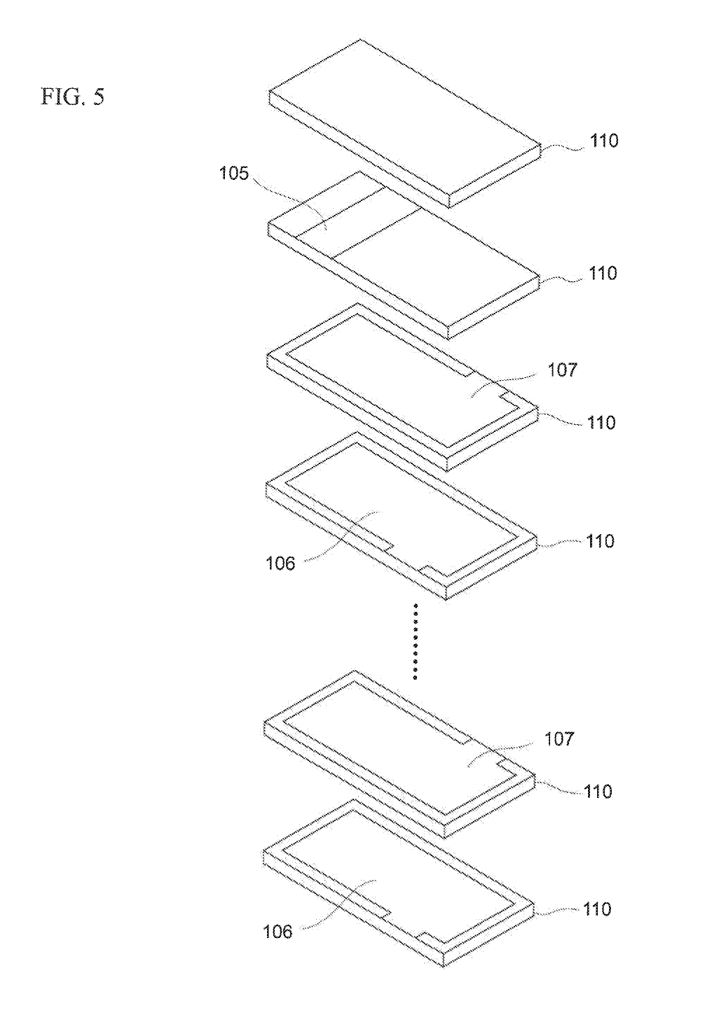

FIG. 5 is an exploded perspective view of the electronic device 1. As illustrated in FIG. 5, the first inner electrodes 106 and the second inner electrodes 107 are alternately stacked with the dielectric 110 interposed therebetween, and hence the stack region 111 is formed. While the first inner electrodes 106 and the second inner electrodes 107 are alternately stacked with the dielectric 110 interposed therebetween in this embodiment, the stacking does not have to be alternate stacking. Also, the connection conductor 105 is stacked to overlap the first inner electrodes 106 and the second inner electrodes 107 via the dielectric 110. The connection conductor 105 may be formed on a surface of the dielectric 110 (the upper surface of the rectangular-parallelepiped shape in FIG. 1).

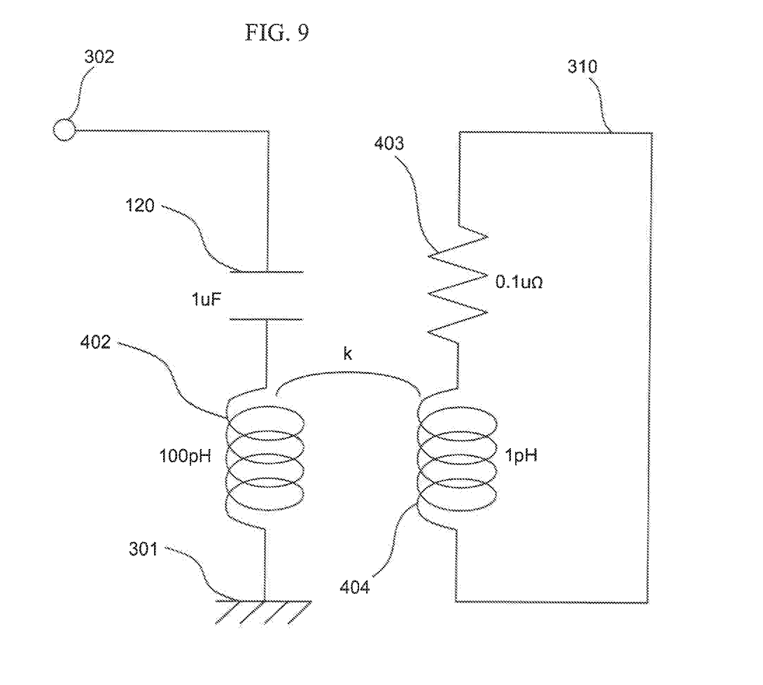

FIG. 7 illustrates a cross-sectional view cut along line A-A in FIG. 1, and FIG. 8 illustrates a cross-sectional view cut along line B-B in FIG. 1, in a state in which the electronic device 1 is mounted on a mount board 300. FIG. 7 illustrates only one first inner electrode 106 and only one second inner electrode 107 for omission. Also, FIG. 8 omits the illustration of the first inner electrode 106 and the second inner electrode 107. One of the first terminal conductor 101 and the second terminal conductor 102 is connected to a ground layer 301 via wiring 304a or wiring 304b of the mount board 300, and the other one is connected to a DC power source layer 302 via the wiring 304a or the wiring 304b of the mount board 300 (in the example in FIG. 7, the first terminal conductor 101 is connected to the ground later 301 via the wiring 304a, and the second terminal conductor 102 is connected to the DC power source layer 302 via the wiring 304b). Also, both the third terminal conductor 103 and the fourth terminal conductor 104 are connected to the DC power source layer 302 via wiring 304c or wiring 304d, and hence a closed loop conductor 310 is formed by the DC power source layer 302, the wiring 304c, 304d of the mount board 300, the connection conductor 105, the third terminal conductor 103, and the fourth terminal conductor 104.

The inductor of the formed loop conductor 310 is coupled to the equivalent series inductor of the capacitor 120, the first terminal conductor 101, the second terminal conductor 102, and the wiring 304a, 304b of the mount board 300, via the generated magnetic field. With this coupling, the magnetic flux generated by noise current passing through the capacitor 120 and the wiring 304a, 304b of the mount board 300 is canceled with the magnetic flux in the opposite direction generated by the eddy current generated at the loop conductor 310 on the basis of Faraday's law, and hence the equivalent series inductor of the capacitor 120, the first terminal conductor 101, the second terminal conductor 102, and the wiring 304a, 304b of the mount board 300 can be decreased.

The principle is described below in detail. An inductance L is defined by Expression (1) as follows by using a current I, a magnetic flux density B, an area S, and a time t. Considering with the definition, an inductance is proportional to the temporal variation in magnetic flux B·dS. Hence, the inductance can be decreased by suppressing the temporal variation in the generated magnetic flux.

$$L = \frac{dI}{dt} = - \frac{d}{dt} \int \int B \cdot dS \qquad ( 1 )$$

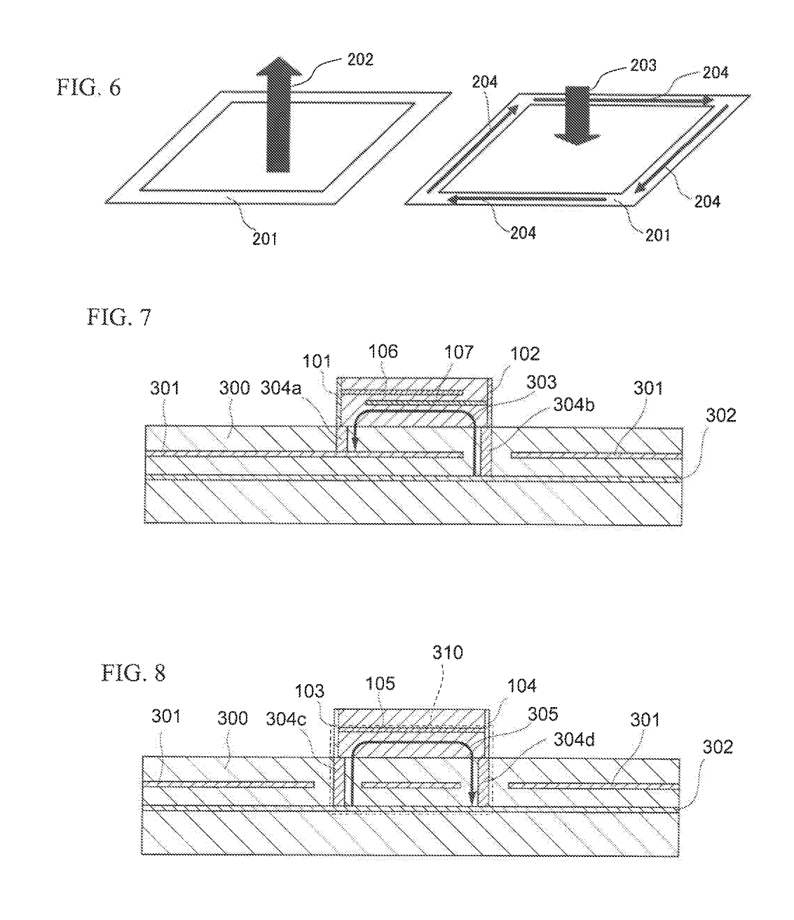

FIG. 6 illustrates a loop conductor 201 that is a closed conductor. When a magnetic flux 202 that penetrates through the inside of the loop of the loop conductor 201 is generated, on the basis of Faraday's law, an electromotive force is generated in a direction to cancel the generated magnetic flux 202, eddy current 204 flows through the loop conductor 201, a magnetic flux 203 in a direction opposite to the direction of the magnetic flux 202 is generated, and the temporal variation in magnetic flux is suppressed.

In FIG. 7, when a noise is generated in the DC power source layer 302, noise current 303 passes through the capacitor 120 formed by the first inner electrodes 106 and the second inner electrodes 107 and flows to the ground layer 301 via the wiring 304a, 304b of the mount board 300. At this time, a magnetic flux is generated in a direction perpendicular to the cross section (paper face in FIG. 7).

As illustrated in FIG. 8, since the connection conductor 105 is connected to the third terminal conductor 103 and the fourth terminal conductor 104, and both the third terminal conductor 103 and the fourth terminal conductor 104 are connected to the DC power source layer 302 via the wiring 304c or 304d of the mount board 300, the closed loop conductor 310 is formed by the connection conductor 105, the third terminal conductor 103, the fourth terminal conductor 104, the wiring 304c, 304d, and the DC power source layer 302. On the basis of Faraday's law, an electromotive force is generated in a direction to disturb an increase in magnetic flux generated when the noise current 303 flows, eddy current 305 in a direction opposite to the direction of the noise current 303 flows through the loop conductor 310, and the eddy current 305 disturbs the temporal variation in magnetic flux generated by the noise current 303. Thus, the equivalent series inductor of the capacitor 120, the first terminal conductor 101, the second terminal conductor 102, and the wiring 304a, 304b of the mount board 300 can be decreased.

As described above, in the electronic device 1, since the third terminal conductor 103 is connected to the fourth terminal conductor 104 by the connection conductor 105, when the electronic device 1 is mounted on the mount board 300, the equivalent series inductance of the capacitor 120, the first terminal conductor 101, the second terminal conductor 102, and the wiring 304a, 304b of the mount board 300 can be decreased.

Further, in the electronic device 1, since the connection conductor 105 is arranged to overlap the first inner electrodes 106 and the second inner electrodes 107 when viewed in the stack direction of the first inner electrodes 106 and the second inner electrodes 107, sufficient magnetic coupling can be obtained between the loop conductor 310 and the equivalent series inductor of the capacitor 120, the first terminal conductor 101, the second terminal conductor 102, and the wiring 304a, 304b of the mount board 300. The equivalent series inductance of the capacitor 120, the first terminal conductor 101, the second terminal conductor 102, and the wiring 304a, 304b of the mount board 300 can be further reliably decreased.

Further, in the electronic device 1, since the connection conductor 105 is formed outside the stack region 111 in which the first inner electrodes 106 and the second inner electrodes 107 are stacked via the dielectric 110, and is not formed in the stack region 111, the equivalent series inductance of the capacitor 120, the first terminal conductor 101, the second terminal conductor 102, and the wiring 304a, 304b of the mount board 300 can be decreased without affecting the capacity of the capacitor.

Further, since the electronic device 1 has the four side surface 11, side surface 12, side surface 13, and side surface 14, and each of the first terminal conductor 101, the second terminal conductor 102, the third terminal conductor 103, and the fourth terminal conductor 104 is formed along one of two side surfaces (the side surface 11 and the side surface 13) from among the four side surface 11, side surface 12, side surface 13, and side surface 14, a terminal conductor is not formed on the residual two side surface 12 and side surface 14 excluding the side surface 11 and the side surface 13. To ensure the reliability, the same type of electronic device or another part is required to be mounted with a certain space with respect to the electronic device 1, at a position facing the side surface 11 or the side surface 13 with a terminal conductor formed. However, the same type of electronic device or another part can be mounted with a reduced space with respect to the electronic device 1, at a position facing the side surface 12 or the side surface 14 without a terminal conductor. A high mounting density of electronic devices and parts can be attained.

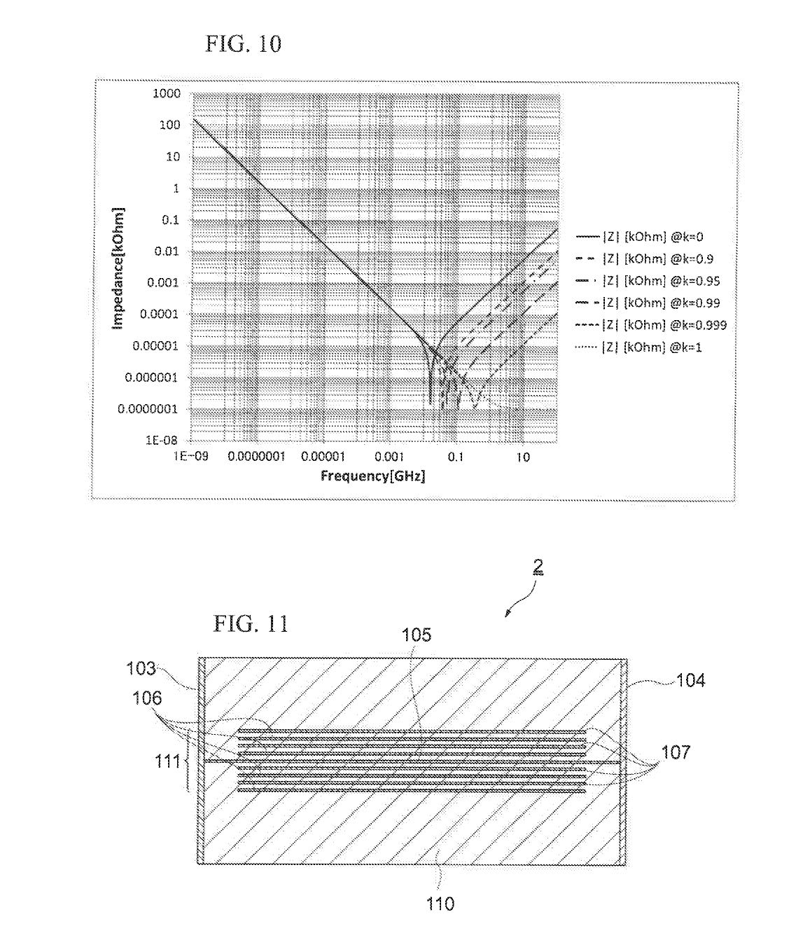

For the state in which the electronic device 1 is mounted on the mount board 300, an equivalent circuit example as illustrated in FIG. 9 is considered. The equivalent circuit example includes a circuit in which the capacitor 120 connected in series between the DC power source layer 302 and the ground layer 301 is connected in series to an equivalent series inductor component 402 of the capacitor 120, the first terminal conductor 101, the second terminal conductor 102, and the wiring 304a or 304b of the mount board 300; and a circuit in which a resistance component 403 and an inductor component 404 of the loop conductor 310 are connected in series. The equivalent series inductor component 402 is coupled to the inductor component 404 by a coupling coefficient k. FIG. 10 shows calculation results by a circuit simulator for an impedance between the DC power source layer 302 and the ground layer 301 in this equivalent circuit example when the capacitance of the capacitor 120 is 1 μF, the inductance of the equivalent series inductor component 402 is 100 pH, the inductance of the inductor component 404 is 1 pH, and the resistance value of the resistance component 403 is 0.1μΩ. It is found from FIG. 10 that, as the coupling coefficient k increases in such a way of 0, 0.9, 0.95, 0.99, 0.999, and 1, the inductance of the equivalent series inductor component 402 decreases, and when the coupling coefficient becomes 1, the inductance of the equivalent series inductor component 402 completely disappears. It is found that when k=0, the case is equivalent to that the loop conductor 310 is not present, and with the presence of the loop conductor 310, the inductance of the equivalent series inductor component 402 decreases.

While the first embodiment has been described with the example in which both the third terminal conductor 103 and the fourth terminal conductor 104 are connected to the DC power source layer 302, both the third terminal conductor 103 and the fourth terminal conductor 104 may be connected to the ground layer 301 via the wiring 304c or the wiring 304d. Even in this case, a closed loop conductor is formed by the ground layer 301, the wiring 304c, 304d, the third terminal conductor 103, the fourth terminal conductor 104, and the connection conductor 105, and hence an advantage similar to the advantage of the electronic device 1 according to the first embodiment can be obtained. Also, the conductor layer to which both the third terminal conductor 103 and the fourth terminal conductor 104 are connected may be another conductor layer different from the ground layer 301 and the DC power source layer 302 as long as a closed loop conductor is formed by the connection conductor, the third terminal conductor 103, the fourth terminal conductor 104, and the connection conductor 105. In this case, the conductor layer is preferably located between the ground layer 301 and the DC power source layer 302.

Also, while the first embodiment has been described with the example of the plurality of first inner electrodes 106 and the plurality of second inner electrodes 107, the number of the first inner electrodes 106 or the number of the second inner electrodes 107 may be one.

Also, while the first embodiment has been described with the example of the dielectric 110 being calcium zirconate or aluminum oxide, a ferromagnetic dielectric may be used as the dielectric 110. By using the ferromagnetic dielectric as the dielectric 110, the magnetic coupling between the loop conductor 310 and the equivalent series inductor owned by the capacitor 120, the first terminal conductor 101, the second terminal conductor 102, and the wiring 304a, 304b of the mount board 300 can be strengthened. The ferromagnetic dielectric may be, for example, ferrite.

Also, while the first embodiment has been described with the example in which the connection conductor 105 is formed above the stack region 111, the connection conductor 105 may be formed below the stack region 111. Also, while the first embodiment has been described with the example of the one connection conductor 105, a plurality of connection conductors 105 may be used.

Also, while the first embodiment has been described with the example in which the connection conductor 105 is arranged to overlap the first inner electrodes 106 and the second inner electrodes 107 when viewed in the stack direction of the first inner electrodes 106 and the second inner electrodes 107, the connection conductor 105 may not be arranged in this way. Even in this case, the equivalent series inductance of the capacitor 120, the first terminal conductor 101, the second terminal conductor 102, and the wiring 304a, 304b of the mount board 300 can be decreased as long as the magnetic coupling is obtained between the equivalent series inductor of the capacitor 120, the first terminal conductor 101, the second terminal conductor 102, and the wiring 304a, 304b of the mount board 300, and the loop conductor including the third terminal conductor 103, the fourth terminal conductor 104, and the connection conductor 105.

Also, while the first embodiment has been described with the example in which the connection conductor 105 is formed outside the stack region 111 in which the first inner electrodes 106 and the second inner electrodes 107 are stacked via the dielectric 110, and is not formed in the stack region 111, the connection conductor 105 may be formed in the stack region 111 like an electronic device 2 according to a second embodiment of the present invention illustrated in FIG. 11. FIG. 11 is a cross-sectional view of the electronic device 2 corresponding to the cross-sectional view of the electronic device 1 illustrated in FIG. 3.

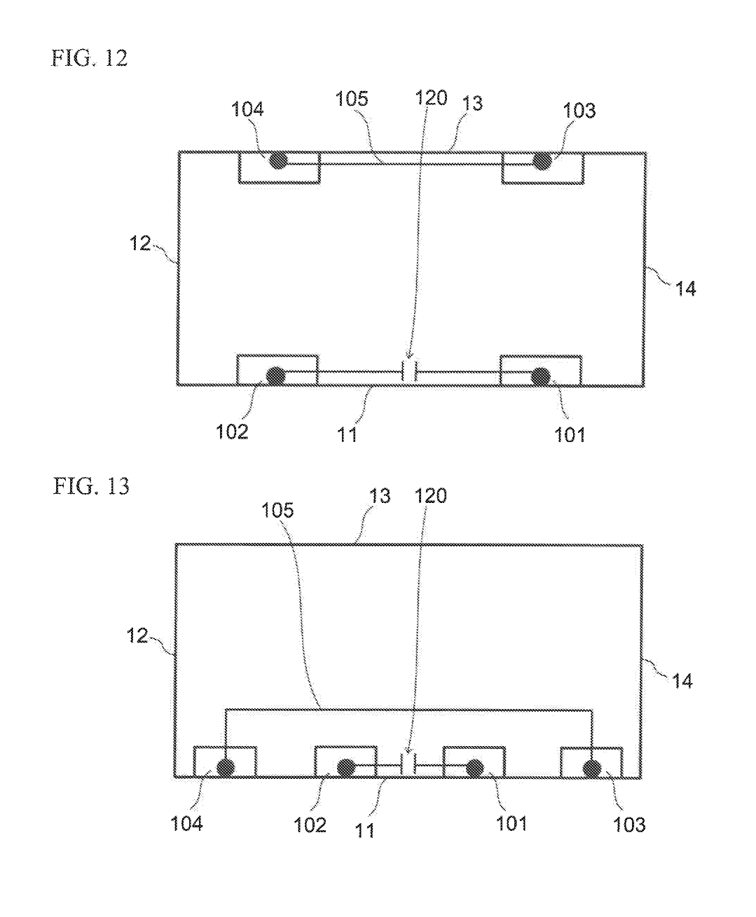

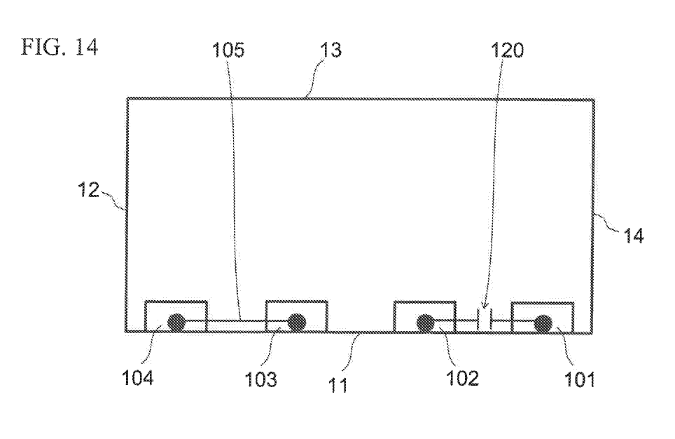

Also, while the first terminal conductor 101 and the second terminal conductor 102 are formed along the different side surfaces (the side surface 11 and the side surface 13) and the third terminal conductor 103 and the fourth terminal conductor 104 are formed along the different side surfaces (the side surface 11 and the side surface 13) in the first embodiment, a side surface along which each terminal conductor is formed is not limited to the aforementioned side surface. For example, as illustrated in FIG. 12, the first terminal conductor 101 and the second terminal conductor 102 may be formed along the same side surface 11, and the third terminal conductor 103 and the fourth terminal conductor 104 may be formed along the same side surface 13. Also, for example, as illustrated in FIG. 13 or 14, the first terminal conductor 101, the second terminal conductor 102, the third terminal conductor 103, and the fourth terminal conductor 104 may be formed along the one side surface 11 from among the four side surface 11, side surface 12, side surface 13, and side surface 14. FIGS. 12 to 14 each illustrate the connection relationship between a topology of a circuit formed in the electronic device and the first to fourth terminal conductors 101, 102, 103, and 104, like FIG. 4.

### Third Embodiment

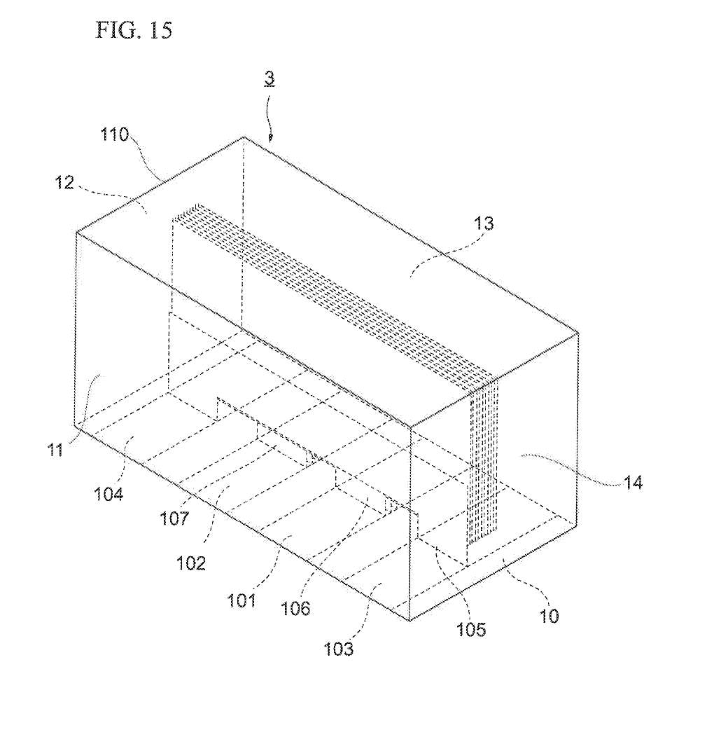

FIG. 15 is a perspective view illustrating a general configuration example of an electronic device 3 according to a third embodiment of the present invention. For the electronic device 3, points different from those of the electronic device 1 according to the first embodiment are mainly described, and the description on common matters is omitted appropriately. The same reference signs are used for elements common to those of the electronic device 1 according to the first embodiment, and the description on the common elements is omitted. In the electronic device 3, the first terminal conductor 101, the second terminal conductor 102, the third terminal conductor 103, and the fourth terminal conductor 104 are formed along the mount surface 10 that is the same bottom surface, and the first inner electrodes 106, the second inner electrodes 107, and the connection conductor 105 are formed to be perpendicular to the mount surface 10.

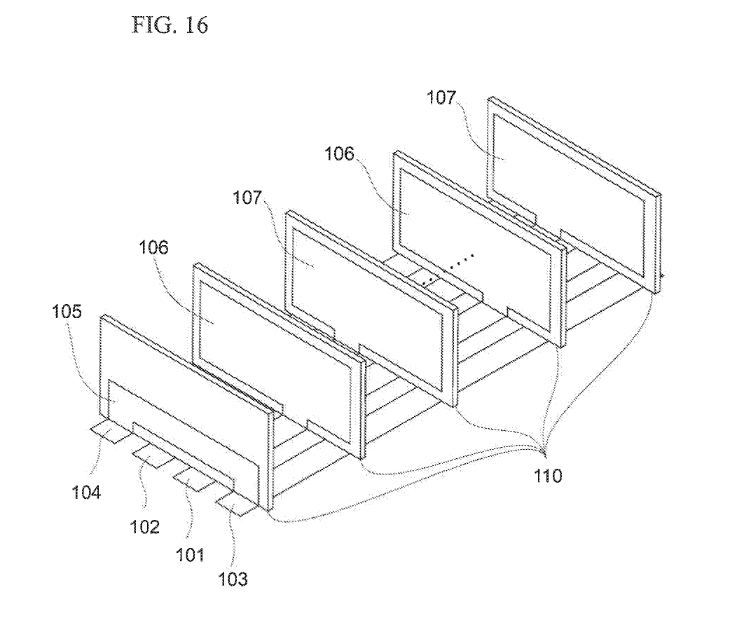

FIG. 16 is an exploded perspective view of the electronic device 3. As illustrated in FIG. 16, the first inner electrodes 106 and the second inner electrodes 107 are stacked via the dielectric 110 in a direction parallel to the mount surface 10.

Like the electronic device 1 according to the first embodiment, the connection conductor 105 is arranged to be separated from the first inner electrodes 106 and the second inner electrodes 107, and is arranged to overlap the first inner electrodes 106 and the second inner electrodes 107 when viewed in the stack direction of the first inner electrodes 106 and the second inner electrodes 107.

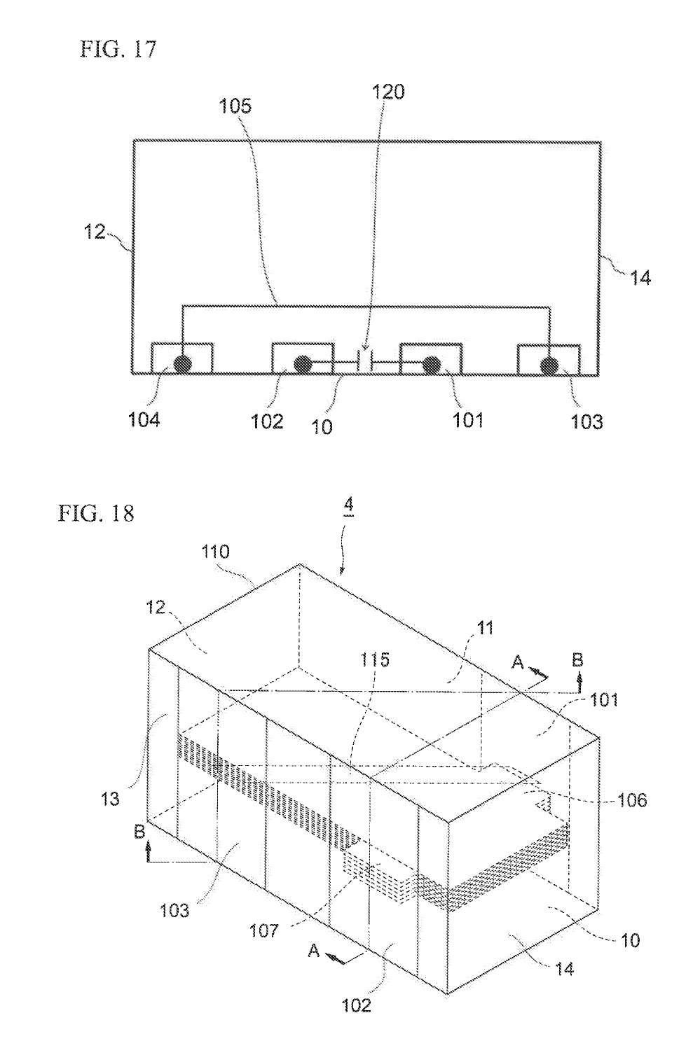

When the connection relationship between a topology of a circuit formed in the electronic device 3 and the first to fourth terminal conductors 101, 102, 103, and 104 is illustrated, the relationship may be one in FIG. 17.

In the electronic device 3, since the third terminal conductor 103 is connected to the fourth terminal conductor 104 by the connection conductor 105 like the electronic device 1 according to the first embodiment, when the electronic device 3 is mounted on the mount board 300, the equivalent series inductance of the capacitor 120, the first terminal conductor 101, the second terminal conductor 102, and the wiring 304a, 304b of the mount board 300 can be decreased.

Further, in the electronic device 3, since the first terminal conductor 101, the second terminal conductor 102, the third terminal conductor 103, and the fourth terminal conductor 104 are formed along the same bottom surface (the mount surface 10), a terminal conductor is not formed on a side surface. Hence, the same type of electronic device or another part can be mounted with a reduced space at a position facing each of the side surfaces without a terminal conductor. A high mounting density of electronic devices and parts can be attained.

### Fourth Embodiment

FIG. 18 is a perspective view illustrating a general configuration example of an electronic device 4 according to a fourth embodiment of the present invention. The electronic device 4 has a rectangular-parallelepiped shape as illustrated in FIG. 18, and has a mount surface 10 (a bottom surface of the electronic device 4 in FIG. 18), a side surface 11, a side surface 12, a side surface 13, and a side surface 14. The side surface 11, the side surface 12, the side surface 13, and the side surface 14 intersect with the mount surface 10. The electronic device 4 includes a first terminal conductor 101, a second terminal conductor 102, and a third terminal conductor 103. Each of the first terminal conductor 101, the second terminal conductor 102, and the third terminal conductor 103 is formed along one side surface from among the four side surface 11, side surface 12, side surface 13, and side surface 14. To be more specific, the first terminal conductor 101 and the second terminal conductor 102 are formed along different side surfaces (the side surface 11 and the side surface 13) (the first terminal conductor 101 is formed along the side surface 11, and the second terminal conductor 102 is formed along the side surface 13). Also, the third terminal conductor 103 is formed along a side surface (the side surface 13) different from the side surface 11 along which the first terminal conductor 101 is formed. The second terminal conductor 102 and the third terminal conductor 103 are formed along the same side surface 13. The first terminal conductor 101, the second terminal conductor 102, and the third terminal conductor 103 are separated from one another via a dielectric 110.

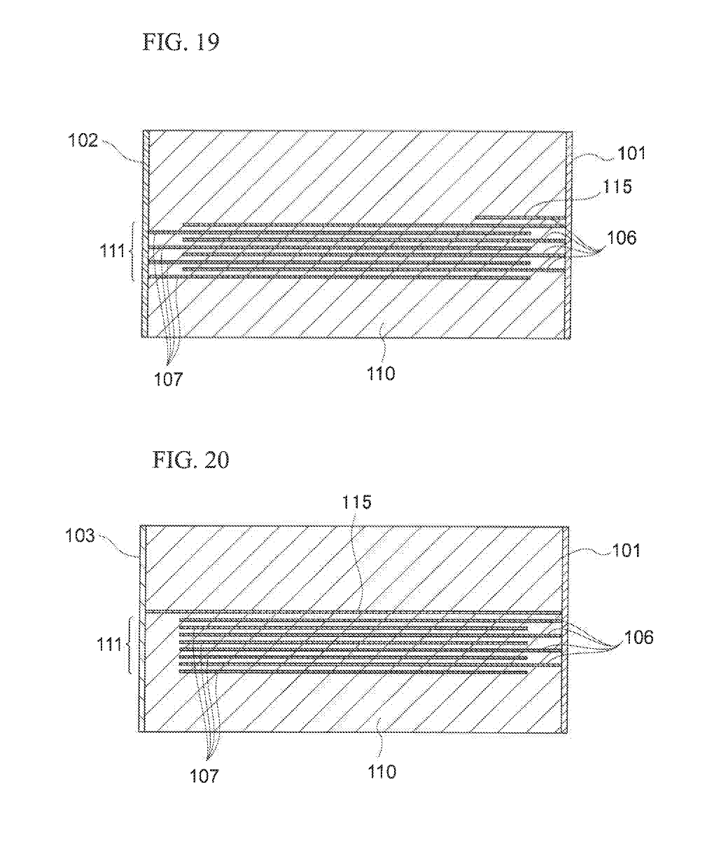

Also, the electronic device 4 includes a plurality of first inner electrodes 106, a plurality of second inner electrodes 107, and a first connection conductor 115. FIG. 19 is a cross-sectional view along line A-A in FIG. 18. As illustrated in FIG. 19, the plurality of first inner electrodes 106 are connected to the first terminal conductor 101, the plurality of second inner electrodes 107 are connected to the second terminal conductor 102, each of the first inner electrodes 106 and each of the second inner electrodes 107 are stacked via the dielectric 110, and hence a stack region 111 is formed. The stack region 111 functions as a capacitor.

An example of the dielectric 110 may be a dielectric ceramic material, such as calcium zirconate or aluminum oxide. Alternatively, the dielectric 110 may be an organic material or an electrolytic solution.

FIG. 20 is a cross-sectional view along line B-B in FIG. 18. As illustrated in FIGS. 18 and 20, the first connection conductor 115 is connected to both the first terminal conductor 101 and the third terminal conductor 103.

Also, as illustrated in FIG. 20, the first connection conductor 115 is arranged to be separated from the first inner electrodes 106 and the second inner electrodes 107. Further, as illustrated in FIGS. 18 and 20, the first connection conductor 115 is arranged to overlap the first inner electrodes 106 and the second inner electrodes 107 when viewed in a stack direction of the first inner electrodes 106 and the second inner electrodes 107.

Also, as illustrated in FIG. 20, the first connection conductor 115 is formed outside the stack region 111, and is not formed in the stack region 111.

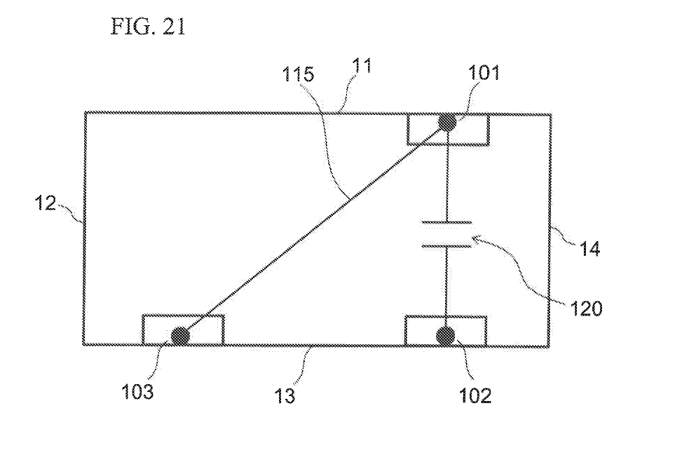

When the connection relationship between a topology of a circuit formed in the electronic device 4 and the first to third terminal conductors 101, 102, and 103 is illustrated, the relationship may be one in FIG. 21. The stack region 111 functions as a capacitor 120. The capacitor 120 is connected between the first terminal conductor 101 and the second terminal conductor 102.

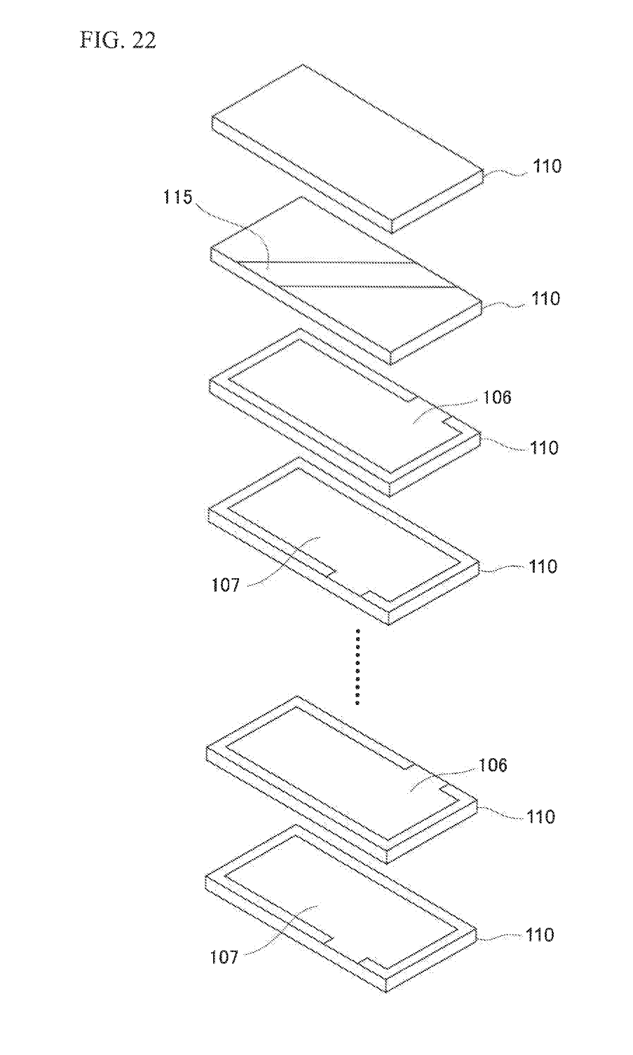

FIG. 22 is an exploded perspective view of the electronic device 4. As illustrated in FIG. 22, the first inner electrodes 106 and the second inner electrodes 107 are alternately stacked via the dielectric 110, and hence the stack region 111 is formed. While the first inner electrodes 106 and the second inner electrodes 107 are alternately stacked via the dielectric 110 in this embodiment, the stacking does not have to be alternate stacking. Also, the first connection conductor 115 is stacked to overlap the first inner electrodes 106 and the second inner electrodes 107 via the dielectric 110. The first connection conductor 115 may be formed on a surface of the dielectric 110 (the upper surface of the rectangular-parallelepiped shape in FIG. 18).

FIG. 24 illustrates a cross-sectional view cut along line A-A in FIG. 18, and FIG. 25 illustrates a cross-sectional view cut along line B-B in FIG. 18, in a state in which the electronic device 4 is mounted on a mount board 300. FIG. 24 illustrates only one first inner electrode 106 and only one second inner electrode 107 for omission. The illustration of the first connection conductor 115 is omitted. Also, FIG. 25 omits the illustration of the first inner electrode 106 and the second inner electrode 107. One of the first terminal conductor 101 and the second terminal conductor 102 is connected to a ground layer 301 via wiring 304a or wiring 304b of the mount board 300, and the other one is connected to a DC power source layer 302 via the wiring 304a or the wiring 304b of the mount board 300 (in the example in FIG. 24, the second terminal conductor 102 is connected to the ground later 301 via the wiring 304b, and the first terminal conductor 101 is connected to the DC power source layer 302 via the wiring 304a). Also, the third terminal conductor 103 is connected to the DC power source layer 302 that is a layer with the same electric potential as that of the first terminal conductor 101 via the wiring 304c, and hence a closed first loop conductor 320 is formed by the DC power source layer 302, the wiring 304a, 304c of the mount board 300, the first connection conductor 115, the first terminal conductor 101, and the third terminal conductor 103.

The inductor of the formed first loop conductor 320 is coupled to the equivalent series inductor of the capacitor 120, the first terminal conductor 101, the second terminal conductor 102, and the wiring 304a, 304b of the mount board 300, via the generated magnetic field. With this coupling, the magnetic flux generated by noise current passing through the capacitor 120 and the wiring 304a, 304b of the mount board 300 is canceled with the magnetic flux in the opposite direction generated by the eddy current generated at the first loop conductor 320 on the basis of Faraday's law, and hence the equivalent series inductance of the capacitor 120, the first terminal conductor 101, the second terminal conductor 102, and the wiring 304a, 304b of the mount board 300 can be decreased.

The principle is described below in detail. An inductance L is defined by Expression (1) as follows by using a current I, a magnetic flux density B, an area S, and a time t. Considering with the definition, an inductance is proportional to the temporal variation in magnetic flux B·dS. Hence, the inductance can be decreased by suppressing the temporal variation in the generated magnetic flux.

$$L = \frac{dI}{dt} = - \frac{d}{dt} \int \int B \cdot dS \qquad ( 1 )$$

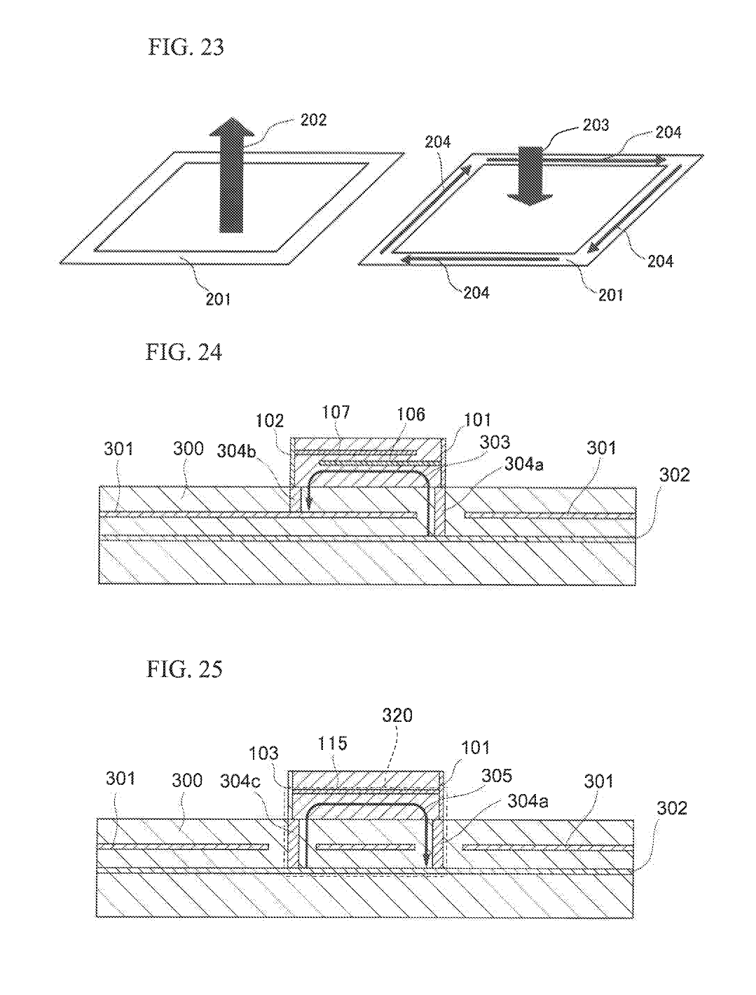

FIG. 23 illustrates a loop conductor 201 that is a closed conductor. When a magnetic flux 202 that penetrates through the inside of the loop of the loop conductor 201 is generated, on the basis of Faraday's law, an electromotive force is generated in a direction to cancel the generated magnetic flux 202, eddy current 204 flows through the loop conductor 201, a magnetic flux 203 in a direction opposite to the direction of the magnetic flux 202 is generated, and the temporal variation in magnetic flux is suppressed.

In FIG. 24, when a noise is generated in the DC power source layer 302, noise current 303 passes through the capacitor 120 formed by the first inner electrodes 106 and the second inner electrodes 107 and flows to the ground layer 301 via the wiring 304a, 304b of the mount board 300. At this time, a magnetic flux is generated in a direction perpendicular to the cross section (paper face in FIG. 24).

As illustrated in FIG. 25, since the first connection conductor 115 is connected to the first terminal conductor 101 and the third terminal conductor 103, and both the first terminal conductor 101 and the third terminal conductor 103 are connected to the DC power source layer 302 via the wiring 304a or the wiring 304c of the mount board 300, a first loop conductor 320 is formed by the first connection conductor 115, the first terminal conductor 101, the third terminal conductor 103, the wiring 304a, the wiring 304c, and the DC power source layer 302. On the basis of Faraday's law, an electromotive force is generated in a direction to disturb an increase in magnetic flux generated when the noise current 303 flows, eddy current 305 in a direction opposite to the direction of the noise current 303 flows through the first loop conductor 320, and the eddy current 305 disturbs the temporal variation in magnetic flux generated by the noise current 303. Thus, the equivalent series inductance of the capacitor 120, the first terminal conductor 101, the second terminal conductor 102, and the wiring 304a, 304b of the mount board 300 can be decreased.

As described above, in the electronic device 4, since the first terminal conductor 101 is connected to the third terminal conductor 103 by the first connection conductor 115, when the electronic device 4 is mounted on the mount board 300, the equivalent series inductance of the capacitor 120, the first terminal conductor 101, the second terminal conductor 102, and the wiring 304a, 304b of the mount board 300 can be decreased.

Further, in the electronic device 4, since the first connection conductor 115 is arranged to overlap the first inner electrodes 106 and the second inner electrodes 107 when viewed in the stack direction of the first inner electrodes 106 and the second inner electrodes 107, sufficient magnetic coupling can be obtained between the first loop conductor 320 including the first connection conductor 115 and the equivalent series inductor of the capacitor 120, the first terminal conductor 101, the second terminal conductor 102, and the wiring 304a, 304b of the mount board 300. The equivalent series inductance of the capacitor 120, the first terminal conductor 101, the second terminal conductor 102, and the wiring 304a, 304b of the mount board 300 can be further reliably decreased.

Further, in the electronic device 4, since the first connection conductor 115 is formed outside the stack region 111 in which the first inner electrodes 106 and the second inner electrodes 107 are stacked via the dielectric 110, and is not formed in the stack region 111, the equivalent series inductance of the capacitor 120, the first terminal conductor 101, the second terminal conductor 102, and the wiring 304a, 304b of the mount board 300 can be decreased without affecting the capacity of the capacitor.

Further, since the electronic device 4 has the four side surface 11, side surface 12, side surface 13, and side surface 14, the first terminal conductor 101 is formed along the side surface 11, and the second terminal conductor 102 and the third terminal conductor 103 are formed along the same side surface 13, a terminal conductor is not formed on the residual two side surface 12 and side surface 14 excluding the side surface 11 and the side surface 13. To ensure the reliability, the same type of electronic device or another part is required to be mounted with a certain space with respect to the electronic device 4, at a position facing the side surface 11 or the side surface 13 with a terminal conductor formed. However, the same type of electronic device or another part can be mounted with a reduced space with respect to the electronic device 4, at a position facing the side surface 12 or the side surface 14 without a terminal conductor. A high mounting density of electronic devices and parts can be attained.

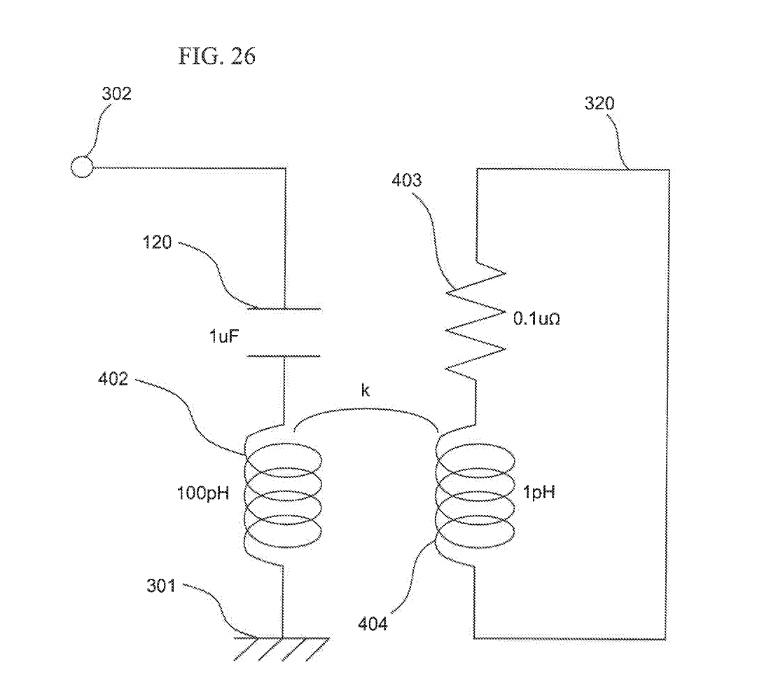

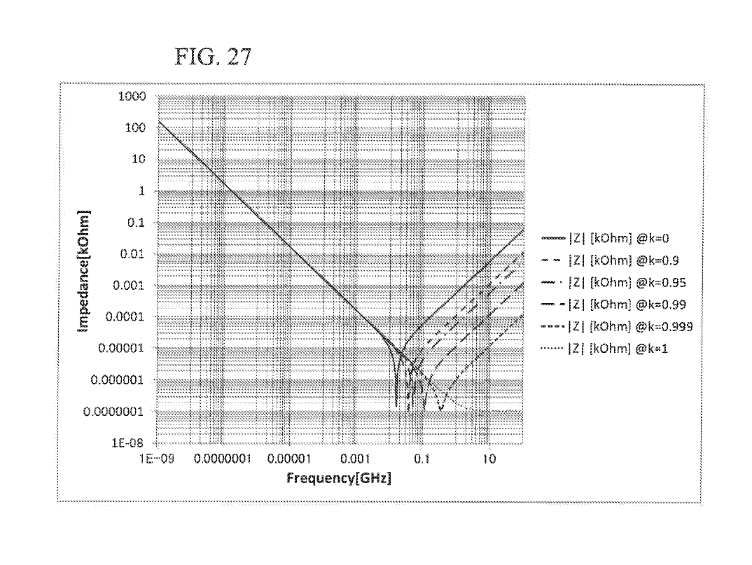

For the state in which the electronic device 4 is mounted on the mount board 300, an equivalent circuit example as illustrated in FIG. 26 is considered. The equivalent circuit example includes a circuit in which the capacitor 120 connected in series between the DC power source layer 302 and the ground layer 301 is connected in series to an equivalent series inductor component 402 of the capacitor 120, the first terminal conductor 101, the second terminal conductor 102, and the wiring 304a, 304b of the mount board 300; and a circuit in which a resistance component 403 and an inductor component 404 of the first loop conductor 320 are connected to each other in series. The equivalent series inductor component 402 is coupled to the inductor component 404 by a coupling coefficient k. FIG. 27 shows calculation results by a circuit simulator for an impedance between the DC power source layer 302 and the ground layer 301 in this equivalent circuit example when the capacitance of the capacitor 120 is 1 μF, the inductance of the equivalent series inductor component 402 is 100 pH, the inductance of the inductor component 404 is 1 pH, and the resistance value of the resistance component 403 is 0.1μΩ. It is found from FIG. 27 that, as the coupling coefficient k increases in such a way of 0, 0.9, 0.95, 0.99, 0.999, and 1, the inductance of the equivalent series inductor component 402 decreases, and when the coupling coefficient becomes 1, the inductance of the equivalent series inductor component 402 completely disappears. It is found that when k=0, the case is equivalent to that the first loop conductor 320 is not present, and with the presence of the first loop conductor 320, the inductance of the equivalent series inductor component 402 decreases.

While the fourth embodiment has been described with the example in which the second terminal conductor 102 is connected to the ground layer 301 via the wiring 304b, and both the first terminal conductor 101 and the third terminal conductor 103 are connected to the DC power source layer 302 via the wiring 304a or the wiring 304c, the second terminal conductor 102 may be connected to the DC power source layer 302 via the wiring 304b, and both the first terminal conductor 101 and the third terminal conductor 103 may be connected to the ground layer 301 via the wiring 304a or the wiring 304c. Even in this case, a closed loop conductor is formed by the ground layer 301, the wiring 304a, 304c, the first terminal conductor 101, the third terminal conductor 103, and the first connection conductor 115, and hence an advantage similar to the advantage of the electronic device 4 according to the fourth embodiment can be obtained.

Also, while the fourth embodiment has been described with the example of the plurality of first inner electrodes 106 and the plurality of second inner electrodes 107, the number of the first inner electrodes 106 or the number of the second inner electrodes 107 may be one.

Also, while the fourth embodiment has been described with the example of the dielectric 110 being calcium zirconate or aluminum oxide, a ferromagnetic dielectric may be used as the dielectric 110. By using the ferromagnetic dielectric as the dielectric 110, the magnetic coupling between the first loop conductor 320 and the equivalent series inductor owned by the capacitor 120, the first terminal conductor 101, the second terminal conductor 102, and the wiring 304a, 304b of the mount board 300 can be strengthened. The ferromagnetic dielectric may be, for example, ferrite.

Also, while the fourth embodiment has been described with the example in which the first connection conductor 115 is formed above the stack region 111, the first connection conductor 115 may be formed below the stack region 111. Also, while the fourth embodiment has been described with the example of the one first connection conductor 115, a plurality of first connection conductors 115 may be used.

Also, while the fourth embodiment has been described with the example in which the first connection conductor 115 is arranged to overlap the first inner electrodes 106 and the second inner electrodes 107 when viewed in the stack direction of the first inner electrodes 106 and the second inner electrodes 107, the first connection conductor 115 may not be arranged in this way. Even in this case, the equivalent series inductance of the capacitor 120, the first terminal conductor 101, the second terminal conductor 102, and the wiring 304a, 304b of the mount board 300 can be decreased as long as the magnetic coupling is obtained between the equivalent series inductor of the capacitor 120, the first terminal conductor 101, the second terminal conductor 102, and the wiring 304a, 304b of the mount board 300, and the loop conductor including the first terminal conductor 101, the third terminal conductor 103, and the first connection conductor 115.

### Fifth Embodiment

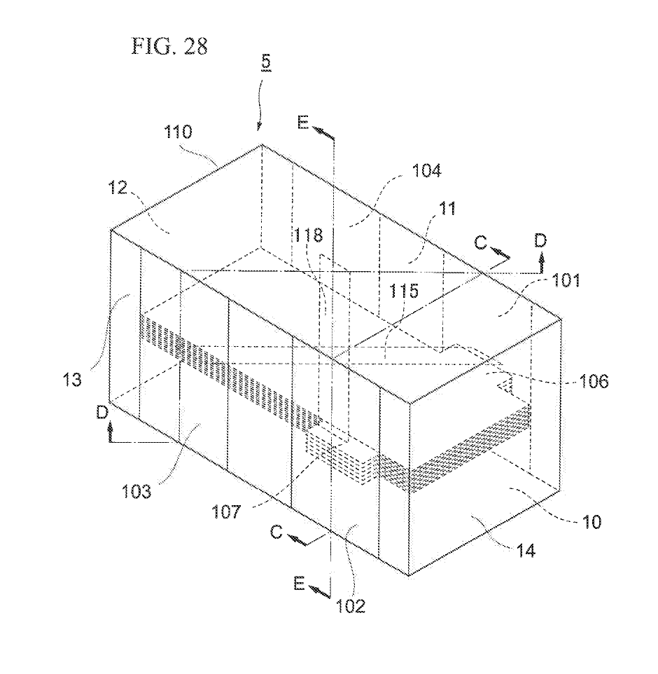

FIG. 28 is a perspective view illustrating a general configuration example of an electronic device 5 according to a fifth embodiment of the present invention. For the electronic device 5, points different from those of the electronic device 4 according to the fourth embodiment are mainly described, and the description on common matters is omitted appropriately. The same reference signs are used for elements common to those of the electronic device 4 according to the fourth embodiment, and the description on the common elements is omitted. The electronic device 5 further includes a fourth terminal conductor 104 and a second connection conductor 118, compared with the electronic device 4 according to the fourth embodiment. The fourth terminal conductor 104 is formed along a side surface (the side surface 11) different from the side surface 13 along which the second terminal conductor 102 is formed. The second terminal conductor 102 and the third terminal conductor 103 are formed along the same side surface 13, and the first terminal conductor 101 and the fourth terminal conductor 104 are formed along the same side surface 11. The first terminal conductor 101, the second terminal conductor 102, the third terminal conductor 103, and the fourth terminal conductor 104 are separated from one another via a dielectric 110.

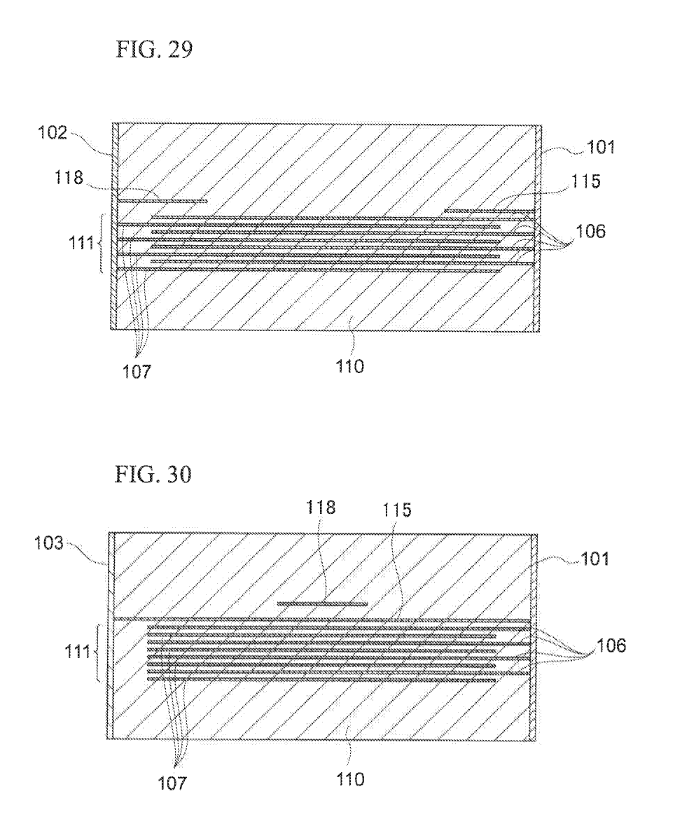

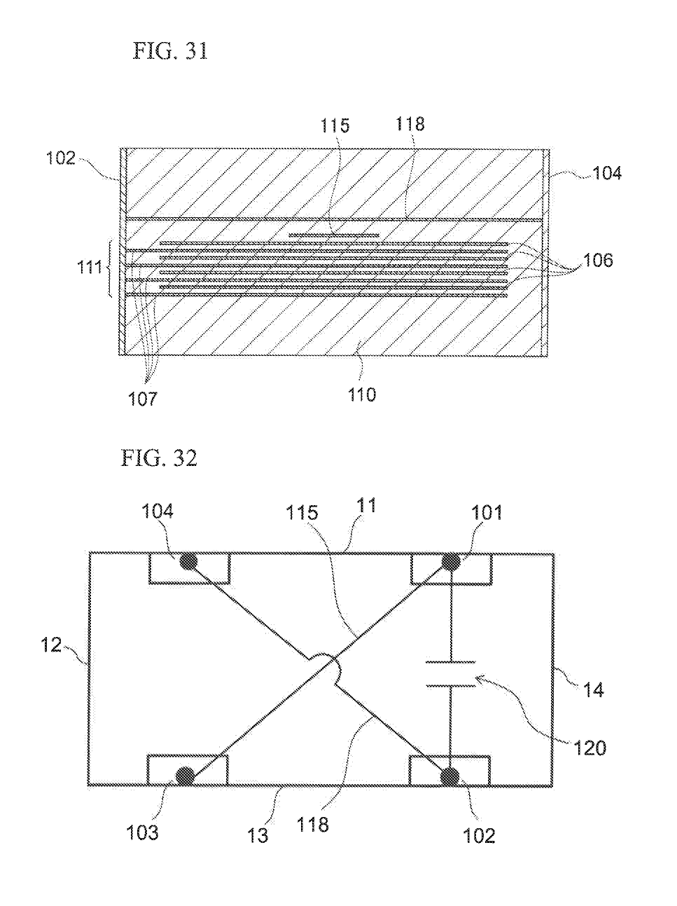

FIG. 29 is a cross-sectional view along line C-C in FIG. 28. FIG. 30 is a cross-sectional view along line D-D in FIG. 28. FIG. 31 is a cross-sectional view along line E-E in FIG. 28. As illustrated in FIGS. 28 and 31, the second connection conductor 118 is connected to both the second terminal conductor 102 and the fourth terminal conductor 104.

Also, as illustrated in FIG. 31, the second connection conductor 118 is arranged to be separated from the first inner electrodes 106, the second inner electrodes 107, and the first connection conductor 115. Further, as illustrated in FIGS. 28 and 31, the second connection conductor 118 is arranged to overlap the first inner electrodes 106 and the second inner electrodes 107 when viewed in a stack direction of the first inner electrodes 106 and the second inner electrodes 107. Further, as illustrated in FIG. 28, the first connection conductor 115 intersects with the second connection conductor 118 when viewed in the stack direction of the first inner electrodes 106 and the second inner electrodes 107.

Also, as illustrated in FIG. 31, the second connection conductor 118 is formed outside the stack region 111, and is not formed in the stack region 111.

When the connection relationship between a topology of a circuit formed in the electronic device 5 and the first to fourth terminal conductors 101, 102, 103, and 104 is illustrated, the relationship may be one in FIG. 32. The stack region 111 functions as a capacitor 120. The capacitor 120 is connected between the first terminal conductor 101 and the second terminal conductor 102.

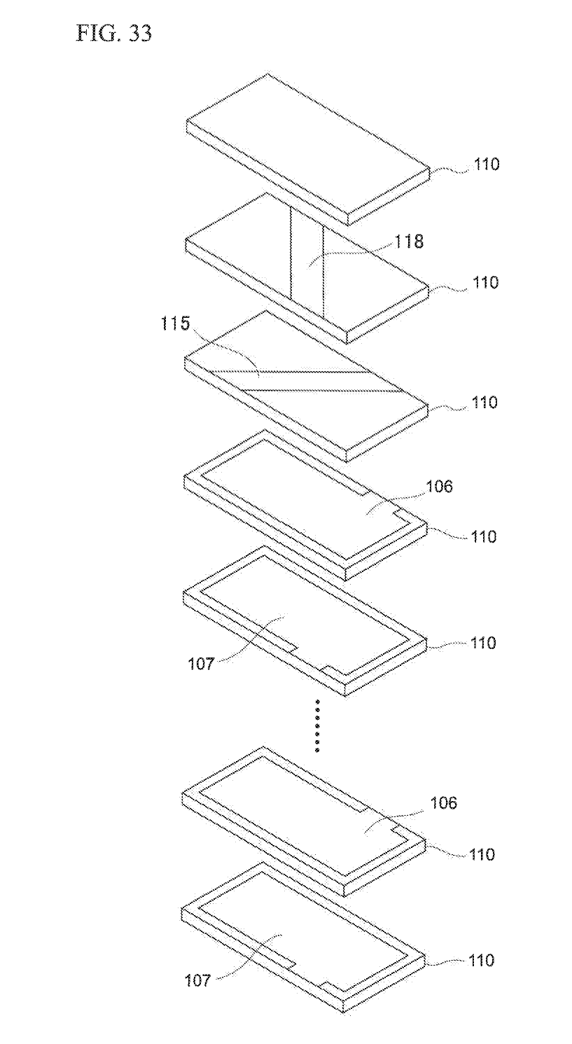

FIG. 33 is an exploded perspective view of the electronic device 5. As illustrated in FIG. 33, the first connection conductor 115 and the second connection conductor 118 are stacked to overlap the first inner electrodes 106 and the second inner electrodes 107 via the dielectric 110. The first connection conductor 115 and the second connection conductor 118 are stacked to be separated from each other via the dielectric 110. The second connection conductor 118 may be formed on a surface of the dielectric 110 (the upper surface of the rectangular-parallelepiped shape in FIG. 28).

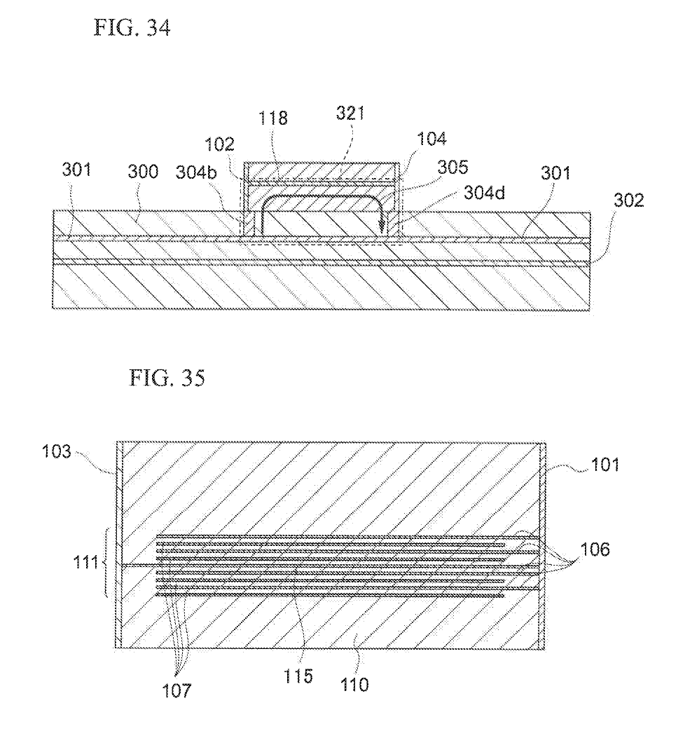

A cross-sectional view cut along line C-C in FIG. 28 can be illustrated in FIG. 24 like the fourth embodiment, and a cross-sectional view cut along line D-D in FIG. 28 can be illustrated in FIG. 25 like the fourth embodiment, in a state in which the electronic device 5 is mounted on a mount board 300. Also, FIG. 34 illustrates a cross-sectional view cut along line E-E in FIG. 28, in the state in which the electronic device 5 is mounted on the mount board 300. FIG. 24 illustrates only one first inner electrode 106 and only one second inner electrode 107 for omission. The illustration of the first connection conductor 115 and the second connection conductor 118 is omitted. Also, FIG. 25 omits the illustration of the first inner electrode 106, the second inner electrode 107, and the second connection conductor 118. FIG. 34 omits the illustration of the first inner electrode 106, the second inner electrode 107, and the first connection conductor 115. The fourth terminal conductor 104 is connected to the ground layer 301 that is a layer with the same electric potential as that of the second terminal conductor 102 via the wiring 304d, and hence a closed second loop conductor 321 is formed by the ground layer 301, the wiring 304b, 304d of the mount board 300, the second connection conductor 118, the second terminal conductor 102, and the fourth terminal conductor 104.

The inductor of the formed second loop conductor 321 is coupled to the equivalent series inductor of the capacitor 120, the first terminal conductor 101, the second terminal conductor 102, and the wiring 304a, 304b of the mount board 300, via the generated magnetic field. Also, the inductor of the first loop conductor 320 is coupled to the equivalent series inductor of the capacitor 120, the first terminal conductor 101, the second terminal conductor 102, and the wiring 304a, 304b of the mount board 300, via the generated magnetic field, like the electronic device 4 according to the fourth embodiment. With these coupling, the magnetic flux generated by noise current passing through the capacitor 120 and the wiring 304a, 304b of the mount board 300 is canceled with the magnetic flux in the opposite direction generated by the eddy current generated at both the first loop conductor 320 and the second loop conductor 321 on the basis of Faraday's law, and hence the equivalent series inductance of the capacitor 120, the first terminal conductor 101, the second terminal conductor 102, and the wiring 304a, 304b of the mount board 300 can be further decreased. As it is found from the calculation results of the simulation provided in the fourth embodiment, the effect of decreasing the equivalent series inductance increases as the coupling coefficient between the equivalent series inductor component and the inductor component of the loop conductor is larger (closer to 1). However, in fact, it is difficult to make the coupling coefficient be 1. Since the electronic device 5 includes the first loop conductor 320 and the second loop conductor 321, even if the coupling coefficient between the inductor component of each of the loop conductors and the equivalent series inductor component is smaller than 1, the effects caused by counter-electromotive forces generated at the respective loop conductors are added, and hence a larger effect of decreasing the equivalent series inductance can be obtained.

As described above, in the electronic device 5, since the fourth terminal conductor 104 and further the second connection conductor 118 are provided as compared with the electronic device 4, the fourth terminal conductor 104 is formed along the side surface 11, and the second terminal conductor 102 and the fourth terminal conductor 104 are connected by the second connection conductor 118, the closed second loop conductor 321 can be further formed because the fourth terminal conductor 104 is connected to the layer (the ground layer 301) with the same electric potential as that of the second terminal conductor 102 via the wiring 304d of the mount board 300, and the equivalent series inductance of the capacitor 120, the first terminal conductor 101, the second terminal conductor 102, and the wiring 304a, 304b of the mount board 300 can be further decreased.

Further, in the electronic device 5, since the second connection conductor 118 is arranged to overlap the first inner electrodes 106 and the second inner electrodes 107 when viewed in the stack direction of the first inner electrodes 106 and the second inner electrodes 107, sufficient magnetic coupling can be obtained between the second loop conductor 321 including the second connection conductor 118 and the equivalent series inductor of the capacitor 120, the first terminal conductor 101, the second terminal conductor 102, and the wiring 304a, 304b of the mount board 300. The equivalent series inductance of the capacitor 120, the first terminal conductor 101, the second terminal conductor 102, and the wiring 304a, 304b of the mount board 300 can be further reliably decreased.

Further, in the electronic device 5, since the second connection conductor 118 is formed outside the stack region 111 in which the first inner electrodes 106 and the second inner electrodes 107 are stacked via the dielectric 110, and is not formed in the stack region 111, the equivalent series inductance of the capacitor 120, the first terminal conductor 101, the second terminal conductor 102, and the wiring 304a, 304b of the mount board 300 can be decreased without affecting the capacity of the capacitor.

Further, since the electronic device 5 has the four side surface 11, side surface 12, side surface 13, and side surface 14, and each of the first terminal conductor 101, the second terminal conductor 102, the third terminal conductor 103, and the fourth terminal conductor 104 is formed along one of two side surfaces (the side surface 11 and the side surface 13) from among the four side surface 11, side surface 12, side surface 13, and side surface 14, a terminal conductor is not formed on the residual two side surface 12 and side surface 14 excluding the side surface 11 and the side surface 13. To ensure the reliability, the same type of electronic device or another part is required to be mounted with a certain space with respect to the electronic device 5, at a position facing the side surface 11 or the side surface 13 with a terminal conductor formed. However, the same type of electronic device or another part can be mounted with a reduced space with respect to the electronic device 5, at a position facing the side surface 12 or the side surface 14 without a terminal conductor. A high mounting density of electronic devices and parts can be attained.

While the fifth embodiment has been described with the example in which both the second terminal conductor 102 and the fourth terminal conductor 104 are connected to the ground layer 301 via the wiring 304b or the wiring 304d, and both the first terminal conductor 101 and the third terminal conductor 103 are connected to the DC power source layer 302 via the wiring 304a or the wiring 304c, both the second terminal conductor 102 and the fourth terminal conductor 104 may be connected to the DC power source layer 302 via the wiring 304b or the wiring 304d, and both the first terminal conductor 101 and the third terminal conductor 103 may be connected to the ground layer 301 via the wiring 304a or the wiring 304c. Even in this case, a closed loop conductor is formed by the ground layer 301, the wiring 304a, 304c, the first terminal conductor 101, the third terminal conductor 103, and the first connection conductor 115, a closed loop conductor is formed by the DC power source layer 302, the wiring 304b, 304d, the second terminal conductor 102, the fourth terminal conductor 104, and the second connection conductor 118, and hence an advantage similar to the advantage of the electronic device 5 according to the fifth embodiment can be obtained.

Also, while the fifth embodiment has been described with the example in which the first connection conductor 115 and the second connection conductor 118 are formed above the stack region 111, one or both the first connection conductor 115 and the second connection conductor 118 may be formed below the stack region 111. Also, while the fourth embodiment has been described with the example of the one first connection conductor 115 and the one second connection conductor 118, a plurality of connection conductors 115 and a plurality of connection conductors 118 may be used.

Also, while the fifth embodiment has been described with the example in which the first connection conductor 115 is formed at a position closer to the stack region 111 than the second connection conductor 118, the second connection conductor 118 may be formed at a position closer to the stack region 111 than the first connection conductor 115.

Also, while the fifth embodiment has been described with the example in which the first connection conductor 115 and the second connection conductor 118 are arranged to overlap the first inner electrodes 106 and the second inner electrodes 107 when viewed in the stack direction of the first inner electrodes 106 and the second inner electrodes 107, one or both the first connection conductor 115 and the second connection conductor 118 may not be arranged in this way. Even in this case, the equivalent series inductance of the capacitor 120, the first terminal conductor 101, the second terminal conductor 102, and the wiring 304a, 304b of the mount board 300 can be decreased as long as the magnetic coupling is obtained between the equivalent series inductor of the capacitor 120, the first terminal conductor 101, the second terminal conductor 102, and the wiring 304a, 304b of the mount board 300; and the loop conductor including the first terminal conductor 101, the third terminal conductor 103, and the first connection conductor 115, and the loop conductor including the second terminal conductor 102, the fourth terminal conductor 104, and the second connection conductor 118.

Also, while the fourth embodiment has been described with the example in which the first connection conductor 115 is formed outside the stack region 111 in which the first inner electrodes 106 and the second inner electrodes 107 are stacked via the dielectric 110, and are not formed in the stack region 111, the first connection conductor 115 may be formed in the stack region 111 like an electronic device 6 according to a sixth embodiment of the present invention illustrated in FIG. 35. FIG. 35 is a cross-sectional view of the electronic device 6 corresponding to the cross-sectional view of the electronic device 4 illustrated in FIG. 20. Likewise, while the fifth embodiment has been described with the example in which the first connection conductor 115 and the second connection conductor 118 are formed outside the stack region 111 in which the first inner electrodes 106 and the second inner electrodes 107 are stacked via the dielectric 110, and are not formed in the stack region 111, one or both the first connection conductor 115 and the second connection conductor 118 may be formed in the stack region 111.

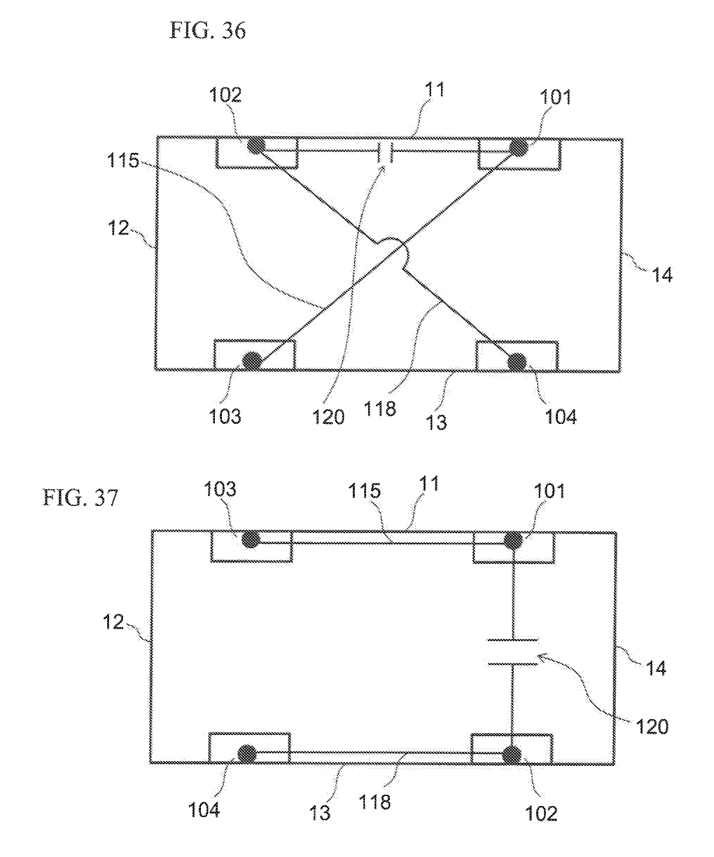

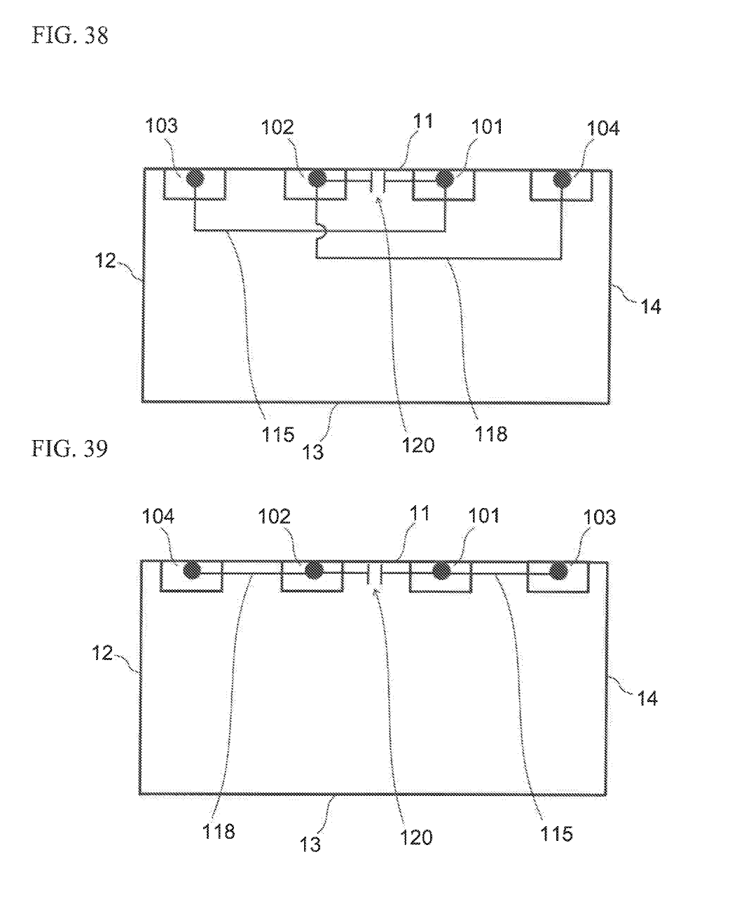

Also, while the first terminal conductor 101 and the second terminal conductor 102 are formed along the different side surfaces (the side surface 11 and the side surface 13) and the third terminal conductor 103 is formed along the side surface (the side surface 13) different from the side surface 11 along which the first terminal conductor 101 is formed in the fourth and fifth embodiments, and while the fourth terminal conductor 104 is formed along the side surface (the side surface 11) different from the side surface along which the second terminal conductor 102 is formed in the fifth embodiment, a side surface along which each terminal conductor is formed is not limited to the aforementioned side surface. For example, as illustrated in FIG. 36, the first terminal conductor 101 and the second terminal conductor 102 may be formed along the same side surface 11, and the third terminal conductor 103 and the fourth terminal conductor 104 may be formed along the same side surface 13. Alternatively, for example, as illustrated in FIG. 37, the first terminal conductor 101 and the third terminal conductor 103 may be formed along the same side surface 11, and the second terminal conductor 102 and the fourth terminal conductor 104 may be formed along the same side surface 13. Still alternatively, for example, as illustrated in FIG. 38 or 39, the first terminal conductor 101, the second terminal conductor 102, the third terminal conductor 103, and the fourth terminal conductor 104 may be formed along the one side surface 11 from among the four side surface 11, side surface 12, side surface 13, and side surface 14. FIGS. 36 to 39 each illustrate the connection relationship between a topology of a circuit formed in the electronic device and the first to fourth terminal conductors 101, 102, 103, and 104, like FIG. 32. Also, an embodiment without the fourth terminal conductor 104 and the second connection conductor 118 like the fourth embodiment may be employed in the examples illustrated in FIGS. 36 to 39.

### Seventh Embodiment

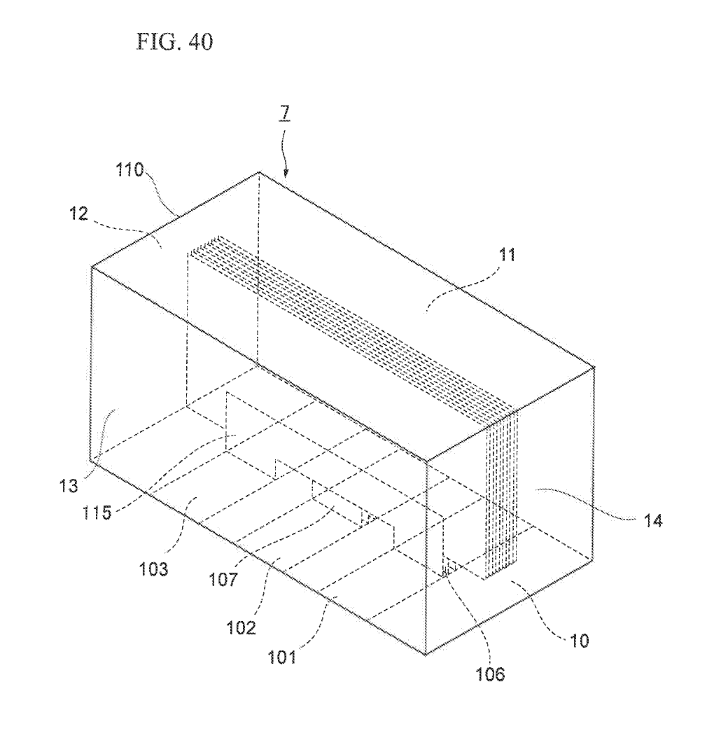

FIG. 40 is a perspective view illustrating a general configuration example of an electronic device 7 according to a seventh embodiment of the present invention. For the electronic device 7, points different from those of the electronic device 4 according to the fourth embodiment are mainly described, and the description on common matters is omitted appropriately. The same reference signs are used for elements common to those of the electronic device 4 according to the fourth embodiment, and the description on the common elements is omitted. In the electronic device 7, the first terminal conductor 101, the second terminal conductor 102, and the third terminal conductor 103 are formed along the mount surface 10 that is the same bottom surface, and the first inner electrodes 106, the second inner electrodes 107, and the first connection conductor 115 are formed to be perpendicular to the mount surface 10.

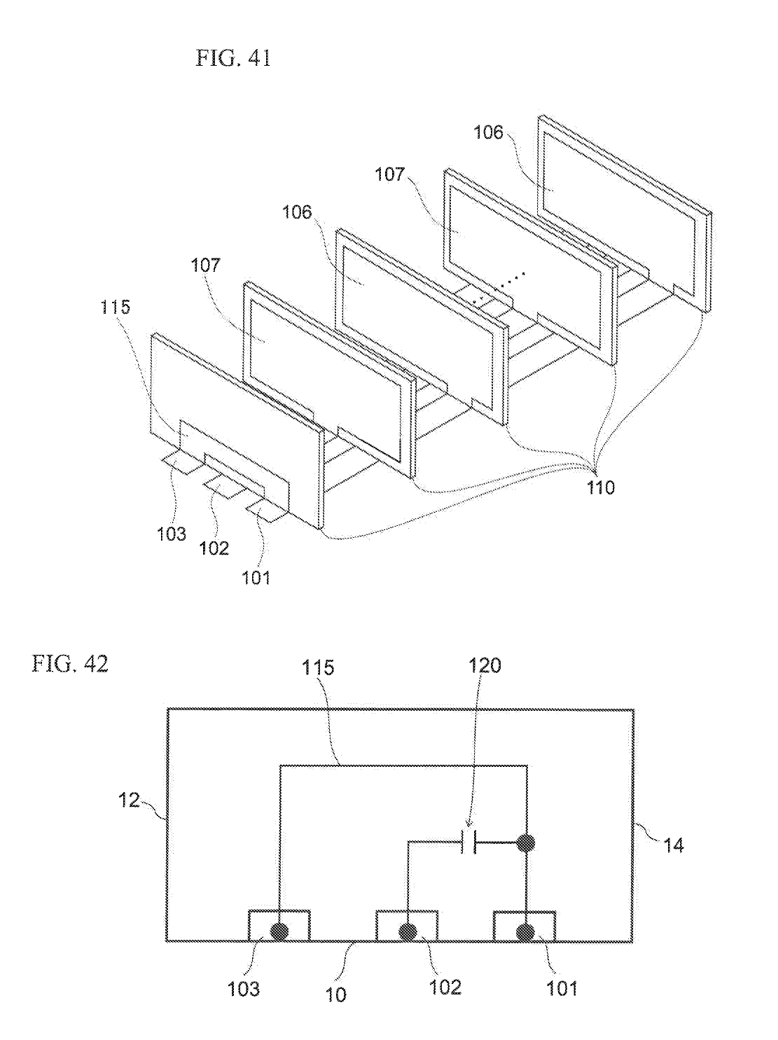

FIG. 41 is an exploded perspective view of the electronic device 7. As illustrated in FIG. 41, the first inner electrodes 106 and the second inner electrodes 107 are stacked via the dielectric 110 in a direction parallel to the mount surface 10.

Like the electronic device 4 according to the fourth embodiment, the first connection conductor 115 is arranged to be separated from the first inner electrodes 106 and the second inner electrodes 107, and is arranged to overlap the first inner electrodes 106 and the second inner electrodes 107 when viewed in the stack direction of the first inner electrodes 106 and the second inner electrodes 107.

When the connection relationship between a topology of a circuit formed in the electronic device 7 and the first to third terminal conductors 101, 102, and 103 is illustrated, the relationship may be one in FIG. 42.

In the electronic device 7, since the first terminal conductor 101 is connected to the third terminal conductor 103 by the first connection conductor 115 like the electronic device 4 according to the fourth embodiment, when the electronic device 7 is mounted on the mount board 300, the equivalent series inductance of the capacitor 120, the first terminal conductor 101, the second terminal conductor 102, and the wiring 304a, 304b of the mount board 300 can be decreased.

Further, in the electronic device 7, since the first terminal conductor 101, the second terminal conductor 102, and the third terminal conductor 103 are formed along the same bottom surface (the mount surface 10), a terminal conductor is not formed on a side surface. Hence, the same type of electronic device or another part can be mounted with a reduced space at a position facing each of the side surfaces without a terminal conductor. A high mounting density of electronic devices and parts can be attained.

### Eighth Embodiment

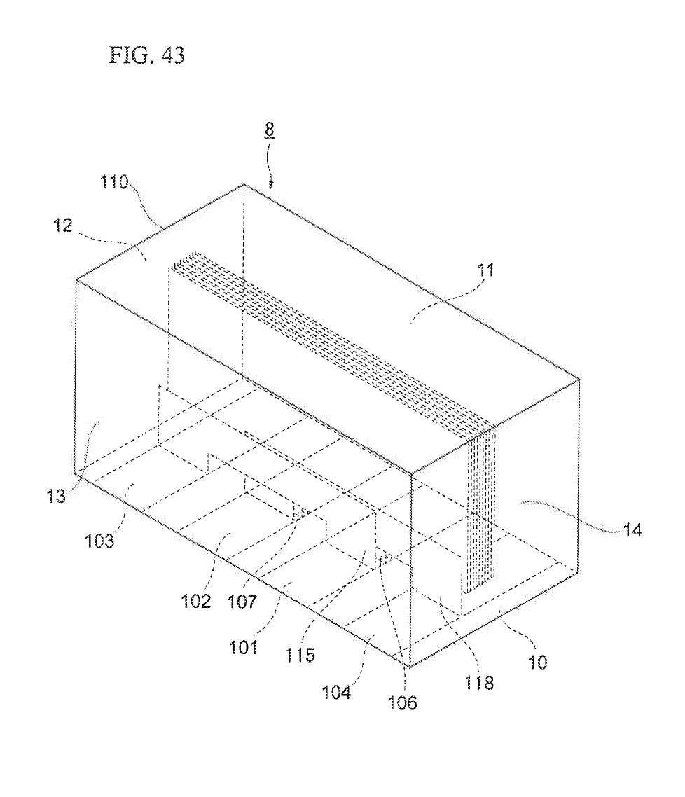

FIG. 43 is a perspective view illustrating a general configuration example of an electronic device 8 according to an eighth embodiment of the present invention. For the electronic device 8, points different from those of the electronic device 5 according to the fifth embodiment are mainly described, and the description on common matters is omitted appropriately. The same reference signs are used for elements common to those of the electronic device 5 according to the fifth embodiment, and the description on the common elements is omitted. In the electronic device 8, the first terminal conductor 101, the second terminal conductor 102, the third terminal conductor 103, and the fourth terminal conductor 104 are formed along the mount surface 10 that is the same bottom surface, and the first inner electrodes 106, the second inner electrodes 107, the first connection conductor 115, and the second connection conductor 118 are formed to be perpendicular to the mount surface 10.

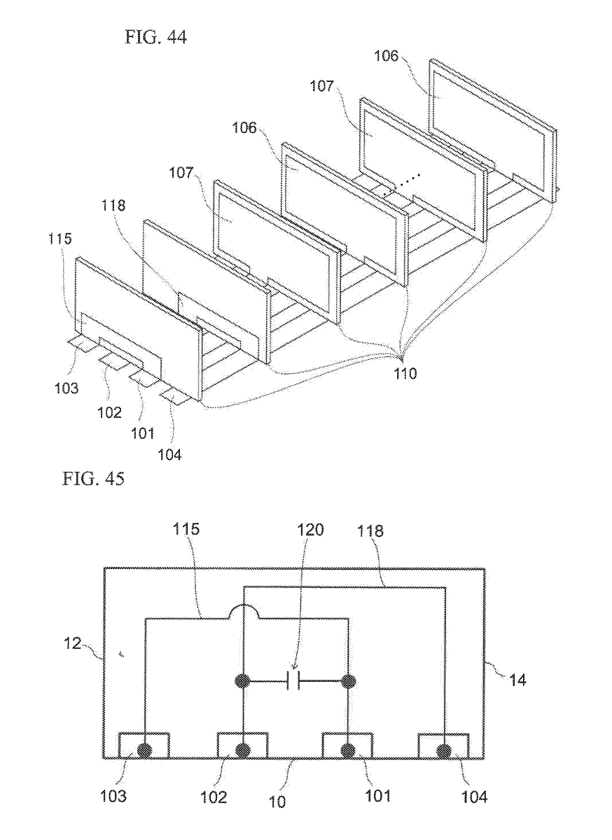

FIG. 44 is an exploded perspective view of the electronic device 8. As illustrated in FIG. 44, the first inner electrodes 106 and the second inner electrodes 107 are stacked via the dielectric 110 in a direction parallel to the mount surface 10.

Like the electronic device 5 according to the fifth embodiment, the first connection conductor 115 and the second connection conductor 118 are arranged to be separated from the first inner electrodes 106 and the second inner electrodes 107, and are arranged to overlap the first inner electrodes 106 and the second inner electrodes 107 when viewed in the stack direction of the first inner electrodes 106 and the second inner electrodes 107.

When the connection relationship between a topology of a circuit formed in the electronic device 8 and the first to fourth terminal conductors 101, 102, 103, and 104 is illustrated, the relationship may be one in FIG. 45.

In the electronic device 8, since the first terminal conductor 101 is connected to the third terminal conductor 103 by the first connection conductor 115 and further the second terminal conductor 102 is connected to the fourth terminal conductor 104 by the second connection conductor 118 like the electronic device 5 according to the fifth embodiment, when the electronic device 8 is mounted on the mount board 300, the equivalent series inductance of the capacitor 120, the first terminal conductor 101, the second terminal conductor 102, and the wiring 304a, 304b of the mount board 300 can be further decreased.

Further, in the electronic device 8, since the first terminal conductor 101, the second terminal conductor 102, the third terminal conductor 103, and the fourth terminal conductor 104 are formed along the same bottom surface (the mount surface 10), a terminal conductor is not formed on a side surface. Hence, the same type of electronic device or another part can be mounted with a reduced space at a position facing each of the side surfaces without a terminal conductor. A high mounting density of electronic devices and parts can be attained.

The electronic device according to any of the above-described first to eighth embodiments may be used for a power source module such as a DC-DC converter; may be used in a set, such as a smartphone, a PC, or a laptop PC; or may be used for a board, such as a graphic board, a microcomputer board, a memory board, or PCI Express board.

### REFERENCE SIGNS LIST

1, 2, 3, 4, 5, 6, 7, 8 electronic device
10 mount surface
11 side surface
12 side surface
13 side surface
14 side surface
101 first terminal conductor
102 second terminal conductor
103 third terminal conductor
104 fourth terminal conductor
105 connection conductor
106 first inner electrode
107 second inner electrode
110 dielectric
111 stack region
115 first connection conductor
118 second connection conductor
120 capacitor
201 loop conductor
202 magnetic flux
203 magnetic flux
204 eddy current
300 mount board
301 ground layer
302 DC power source layer
303 noise current
304a, 304b, 304c, 304d wiring of mount board
305 eddy current
310 loop conductor
320 first loop conductor
321 second loop conductor
402 inductor component
403 resistance component
404 inductor component

1. An electronic device comprising:
a first terminal conductor, a second terminal conductor, a third terminal conductor, and a fourth terminal conductor;
one or a plurality of first inner electrodes, and one or a plurality of second inner electrodes; and
a connection conductor,
wherein the one or plurality of first inner electrodes are connected to the first terminal conductor,
wherein the one or plurality of second inner electrodes are connected to the second terminal conductor,
wherein each of the first inner electrodes and each of the second inner electrodes are stacked via a dielectric, and
wherein the third terminal conductor and the fourth terminal conductor are connected by the connection conductor.

2. The electronic device according to claim 1, wherein the connection conductor is arranged to overlap the first inner electrode and the second inner electrode when viewed in a stack direction of the first inner electrode and the second inner electrode.

3. The electronic device according to claim 2, wherein the connection conductor is formed outside a stack region in which the first inner electrode and the second inner electrode are stacked via the dielectric, and is not formed in the stack region.

4. The electronic device according to claim 1,
wherein the electronic device has four side surfaces, and
wherein each of the first terminal conductor, the second terminal conductor, the third terminal conductor, and the fourth terminal conductor is formed along one of two side surfaces from among the four side surfaces, or
wherein the first terminal conductor, the second terminal conductor, the third terminal conductor, and the fourth terminal conductor are formed along one and the same side surface from among the four side surfaces.

5. The electronic device according to claim 1, wherein the first terminal conductor, the second terminal conductor, the third terminal conductor, and the fourth terminal conductor are formed along the same bottom surface.

6. An electronic device comprising:
a first terminal conductor, a second terminal conductor, and a third terminal conductor,
one or a plurality of first inner electrodes, and one or a plurality of second inner electrodes; and
a first connection conductor,
wherein the one or plurality of first inner electrodes are connected to the first terminal conductor,
wherein the one or plurality of second inner electrodes are connected to the second terminal conductor,
wherein each of the first inner electrodes and each of the second inner electrodes are stacked via a dielectric, and
wherein the first terminal conductor and the third terminal conductor are connected by the first connection conductor.

7. The electronic device according to claim 6, wherein the first connection conductor is arranged to overlap the first inner electrode and the second inner electrode when viewed in a stack direction of the first inner electrode and the second inner electrode.

8. The electronic device according to claim 7, wherein the first connection conductor is formed outside a stack region in which the first inner electrode and the second inner electrode are stacked via the dielectric, and is not formed in the stack region.

9. The electronic device according to claim 6,
wherein the electronic device has four side surfaces,
wherein each of the first terminal conductor, the second terminal conductor, and the third terminal conductor is formed along one side surface from among the four side surfaces, and
wherein at least two of the first terminal conductor, the second terminal conductor, and the third terminal conductor are formed along the same side surface.

10. The electronic device according to claim 6, wherein the first terminal conductor, the second terminal conductor, and the third terminal conductor are formed along the same bottom surface.

11. The electronic device according to claim 6, further comprising:
a fourth terminal conductor and a second connection conductor,
wherein the second terminal conductor and the fourth terminal conductor are connected by the second connection conductor.

12. The electronic device according to claim 11, wherein the second connection conductor is arranged to overlap the first inner electrode and the second inner electrode when viewed in a stack direction of the first inner electrode and the second inner electrode.

13. The electronic device according to claim 12, wherein the second connection conductor is formed outside the stack region in which the first inner electrode and the second inner electrode are stacked via the dielectric, and is not formed in the stack region.

14. The electronic device according to claim 11,
wherein the electronic device has four side surfaces, and
wherein each of the first terminal conductor, the second terminal conductor, the third terminal conductor, and the fourth terminal conductor is formed along one of two side surfaces from among the four side surfaces, or
wherein the first terminal conductor, the second terminal conductor, the third terminal conductor, and the fourth terminal conductor are formed along one and the same side surface from among the four side surfaces.

15. The electronic device according to claim 11, wherein the first terminal conductor, the second terminal conductor, the third terminal conductor, and the fourth terminal conductor are formed along the same bottom surface.
